(19) United States
(12) Patent Application Publication
(10) Pub. No.: US 2006/0143133 A1
(43) Pub. Date: Jun. 29, 2006

(54) Flexible pricing model for persistent content

(76) Inventor: Alexander Medvinsky, San Diego, CA (US)

Correspondence Address: MAYER & WILLIAMS PC, 251 NORTH AVENUE WEST, 2ND FLOOR, WESTFIELD, NJ, 07090, US

(21) Appl. No.: 11/021,772

(22) Filed: Dec. 23, 2004

(51) Int. Cl. G06F 17/60

(52) U.S. Cl. 705/59

(57) ABSTRACT

A digital rights management method (250) and apparatus (10) for protecting digital content enables a flexible pricing model to be implemented that accounts for a subscriber's current subscription type. The digital rights management method (250) provides (251) a purchase option element for each protected digital content. This purchase option element includes specifying a set of content usage rules (which may or may not allow for the content to be saved persistently). The digital rights management method (250) also includes specifying (252) a cost for each protected digital content associated with the set of content usage rules. The digital rights management method (250) also includes specifying (253) a subscription group for the protected digital content associated with a set of content usage rules, which subscription group includes one or more subscription services and one or more associated incremental discounts for the protected digital content based on the one or more associated subscription services.

### RELATED APPLICATIONS

The present invention is related to U.S. patent application Ser. No. 10/933,011, filed on Sep. 2, 2004 by the same inventor, which application is hereby incorporated by reference as if repeated herein in its entirety, including the drawings.

### FIELD OF THE INVENTION

The present invention relates generally to methods and apparatuses for protecting digital information from unauthorized copying, and more particularly to a method and apparatus for protecting digital information from unauthorized copying during transfers among various computers in a network.

### BACKGROUND

In conventional broadcast digital television systems, typically content can either be obtained under a subscription or purchased as Pay-Per-View with a one-time charge. Some content delivery systems may in addition charge a user based on time that a particular program (e.g., Summer Olympics) was viewed (this is called Pay-By-Time). This type of pricing model appears to be inadequate when expressing content usage rules and pricing together in a general language (e.g., XML) that is to be used by many different content providers that could have very different business models.

Several examples of additional business scenarios that are not addressed by the existing DRM follow. First, consider the case in which a user subscribes to a pay-per-view service where pay-per-view movies may be obtained under subscription with no extra charge. If the user wants to make a temporary recording of a movie as it is being viewed, however, there is an incremental charge. For other users that do not subscribe to any service, they can obtain the same pay-per-view content for a charge and for a bigger charge can also make a temporary recording of the movie. The temporary recording of the movie will have specific restrictions, e.g., it expires after one week or can only be played three times. This scenario cannot be accommodated under the existing DRM.

Second, consider the same situation as above, but in which there is an additional premium subscription service that would allow a user to make temporary recordings of movies for no extra charge. This scenario also cannot be accommodated under the existing DRM.

Third, consider the same situation as above, but in which there is an additional purchase option for the movie that allows the user to keep a copy of the movie forever (but not copy it to other users). This purchase option is not available for free under any subscription service, but users that subscribe to a premium service can purchase the movie to keep at a discounted price. This scenario also cannot be accommodated under the existing DRM.

The present invention is therefore directed to the problem of developing a method and apparatus for enabling a content provider to specify with flexibility a pricing model under a digital rights management system to accommodate multiple usage scenarios.

### SUMMARY OF THE INVENTION

The present invention solves these and other problems by providing a method for expressing a pricing model for subscribers and customers of information content, such as video services, that takes into account the subscriber's (or customer's) existing subscription (or lack thereof) when pricing requested content.

According to one aspect of the present invention, a digital rights management method for protecting digital content enables a flexible pricing model to be implemented that accounts for a subscriber's current subscription type. The digital rights management method provides a purchase option element for each protected digital content. This purchase option element includes specifying a set of content usage rules (which may or may not allow for the content to be saved persistently). The digital rights management method also includes specifying a cost for each protected digital content associated with the set of content usage rules. The digital rights management method also includes specifying a subscription group for the protected digital content in the persistent and non-persistent copyright protection rules, which subscription group includes one or more subscription services and one or more associated incremental discounts for the protected digital content based on the one or more associated subscription services. The digital rights management method may also include permitting a subscriber to access and store the content possibly at no cost or at a reduced price based on the discount, if any, that is associated with the subscriber's subscription service and the specified set of content usage rules. The digital rights management method may also include receiving a request from a user indicating a desired content and a selected set of content usage rules (which may or may not allow for the content to be saved persistently) or determining a price for the request based on the user's subscription type, a desired content and the selected set of content usage rules.

### BRIEF DESCRIPTION OF THE DRAWINGS

FIG. 1 depicts a Session Rights Element, which is part of an exemplary embodiment of a copyright protection scheme according to one aspect of the present invention.

FIG. 2 depicts a Rule Element, which is part of an exemplary embodiment of a copyright protection scheme according to one aspect of the present invention.

FIG. 3 depicts a Purchase Option Element, which is part of an exemplary embodiment of a copyright protection scheme according to one aspect of the present invention.

FIG. 4 depicts a Subscription Element, which is part of an exemplary embodiment of a copyright protection scheme according to one aspect of the present invention.

FIG. 5 depicts a Blackout Element, which is part of an exemplary embodiment of a copyright protection scheme according to one aspect of the present invention.

FIG. 6 depicts a Generic Rating Element, which is part of an exemplary embodiment of a copyright protection scheme according to one aspect of the present invention.

FIG. 7 depicts a Selection Element, which is part of an exemplary embodiment of a copyright protection scheme according to one aspect of the present invention.

FIG. 8 depicts a User Authorization Element, which is part of an exemplary embodiment of a copyright protection scheme according to one aspect of the present invention.

FIG. 9 depicts a Persistent Entitlements Element, which is part of an exemplary embodiment of a copyright protection scheme according to one aspect of the present invention.

FIG. 10 depicts a Rule Set Element, which is part of an exemplary embodiment of a copyright protection scheme according to one aspect of the present invention.

FIG. 11 depicts a Redistribution Element, which is part of an exemplary embodiment of a copyright protection scheme according to one aspect of the present invention.

FIG. 12 depicts a Playback Element, which is part of an exemplary embodiment of a copyright protection scheme according to one aspect of the present invention.

FIG. 13 depicts an Option Cost Element, which is part of an exemplary embodiment of a copyright protection scheme according to one aspect of the present invention.

FIG. 14 depicts an IPRM Persistent Entitlements element, which is part of an exemplary embodiment of a copyright protection scheme according to one aspect of the present invention.

FIG. 15 depicts an exemplary embodiment of a copyright protection method for files according to one aspect of the present invention.

FIG. 16 depicts an exemplary embodiment of a first protection scheme employed in the method shown in FIG. 15 according to another aspect of the present invention.

FIG. 17 depicts an exemplary embodiment of a second protection scheme employed in the method shown in FIG. 15 according to still another aspect of the present invention.

FIG. 18 depicts an exemplary embodiment of a third protection scheme that may be employed in the method shown in FIG. 15 according to yet another aspect of the present invention.

FIG. 19 depicts an exemplary embodiment of an apparatus in which the method shown in FIG. 15 may be employed according to another aspect of the present invention.

FIG. 20 depicts an exemplary embodiment of a computer readable media in which the method shown in FIG. 15 may be employed according to another aspect of the present invention.

FIG. 21 depicts an exemplary embodiment of an apparatus for distributing content to a user according to one aspect of the present invention.

FIG. 22 depicts an exemplary embodiment of an apparatus for distributing content to a user according to another aspect of the present invention.

FIG. 23 depicts an exemplary embodiment of an apparatus for distributing content to a user according to still another aspect of the present invention.

FIG. 24 depicts an exemplary embodiment of a digital rights management method according to still another aspect of the present invention.

FIG. 25 depicts another exemplary embodiment of a digital rights management method according to yet another aspect of the present invention.

### DETAILED DESCRIPTION

It is worthy to note that any reference herein to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

One Digital Rights Management (DRM) system addresses the pricing model as follows:

i) Because persistent content rules can get very complex, to simplify the pricing model it will not be possible for a user to choose some arbitrary set of content rules. Instead there is a limited number of sets of rules defined for one piece of content, where each set has its own associated pricing.

ii) By using tier bits in this DRM system, a set of content rules can be associated with one or more subscription services.

iii) A more complex pricing model is where depending on user's subscription (e.g., basic, premium or platinum) the same set of content rules may be offered either for free or for some incremental cost specific to a subscription level. Because this DRM system lists only a single cost for each DRM set, in order to support such more complex pricing scenarios it would have to duplicate the same set of content rules multiple times—each time with a different set of tier bits (corresponding to a different subscription) and also a different incremental price with that subscription. This may be less of a problem for compact content rules encodings, but in the case of IPRM content rules are complex and verbose (encoded using XML) and it is undesirable to repeat them multiple times.

The pricing model still does not address scenarios when a purchase option (e.g., for making a temporary copy of the content) is not fully covered by a subscription service, but can be obtained at a discounted price through that service.

According to one aspect of the present invention, a new pricing model associates a price with each subscription service listed under a set of content rules. If the price is not listed, the subscription allows the subscriber to get that rule set for free. If the price is listed, the price may be a discounted price that subscribers still have to pay to obtain content under the specified set of rules. Instead of listing the absolute discounted price under each subscription, it is also possible to list the discount under the subscription, where the discount would be subtracted from the one-time-pay price for non-subscribers.

In the following Copyright Protection Method, the Session Rights XML schema has a list of PurchaseOption elements, where each option defines content usage rules as well as pricing associated with that option. The actual details of the content usage rules are defined in the Persistent Entitlements XML schema and in the Copy Protection Rules XML schema. A user selects a specific purchase option, which is cross-referenced inside the Selection element of the Session Rights. That option may still have multiple prices listed, one for one-time-pay or pay-by-time with no subscription and various incremental costs associated with different subscription services. In order to determine the lowest price that the user needs to pay, one needs to check Authorization Data XML schema that lists different services to which this user is subscribed.

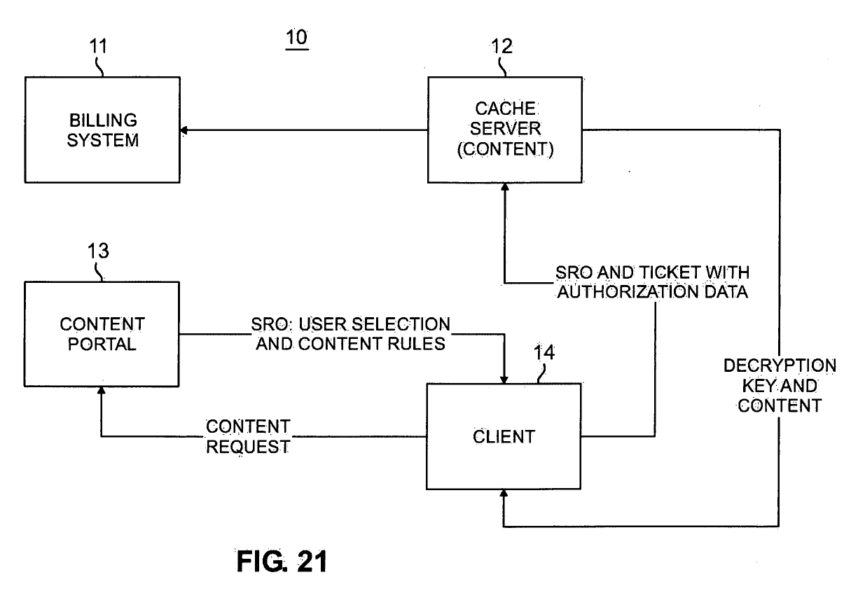

Turning to FIG. 21, shown therein is an exemplary embodiment of an apparatus 10 for distributing protected content to a client 14, such as a set top box or personal computer. Cache server 12 stores content being requested by client 14 via content portal 13. In the request, the client will specify the desired content along with any persistence requirement, such as a temporary recording (enabling pause, rewind, and fast forward features, etc.), a time limited recording (one day, one week, one month, etc.) or a permanent recording. The cost of these for the given content is included in an on-screen display or via an electronic programming guide, for example. Upon receipt of a content request from the client 14, the content portal 13 sends a Session Rights Object (SRO) that includes the content rules and user selection to the client 14. The client 14 then transmits an SRO along with a ticket containing client Authorization Data to the cache server 12, which downloads the content in encrypted form along with a decryption key. A billing system 11 is informed of this event and in turn the billing system 11 eventually charges the client in the normal manner.

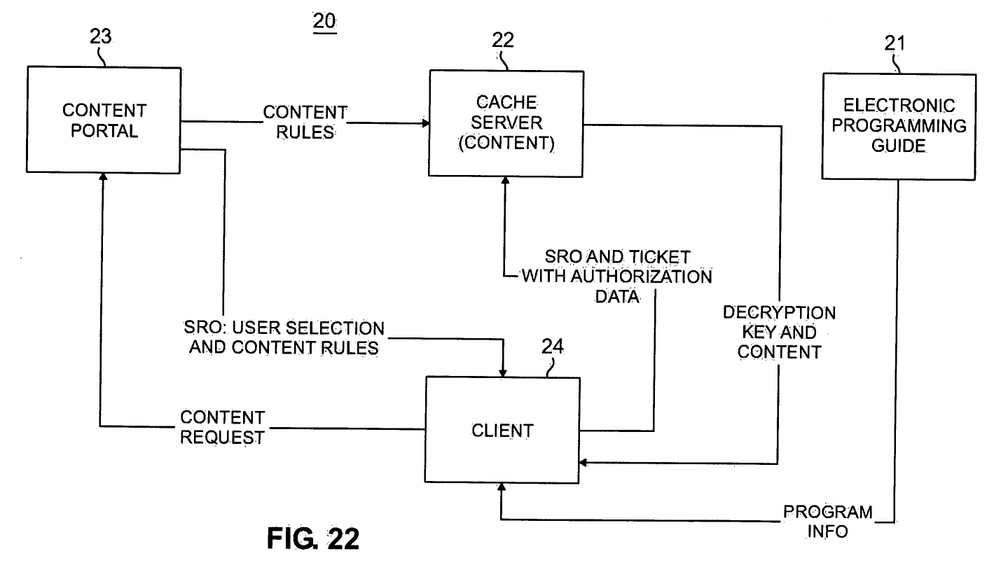

Turning to FIG. 22, shown therein is an exemplary embodiment of an apparatus 20 for distributing protected content to a client 24, such as a set top box or personal computer. Cache server 22 stores content being requested by client 24 via content portal 23. Upon receipt of a content request from the client 24, the content portal 23 sends a Session Rights Object (SRO) that includes the Purchase Option selected by the user (normally containing a set of persistent data entitlements or copy protection rules) to the client 24. The client 24 then transmits a SRO along with a ticket that includes client Authorization Data to the cache server 22, where the client then downloads the content in encrypted form along with a decryption key. Electronic Programming Guide 21 transmits program information to the client 24 in the normal manner. A billing system (not shown) is informed of the event in the normal manner.

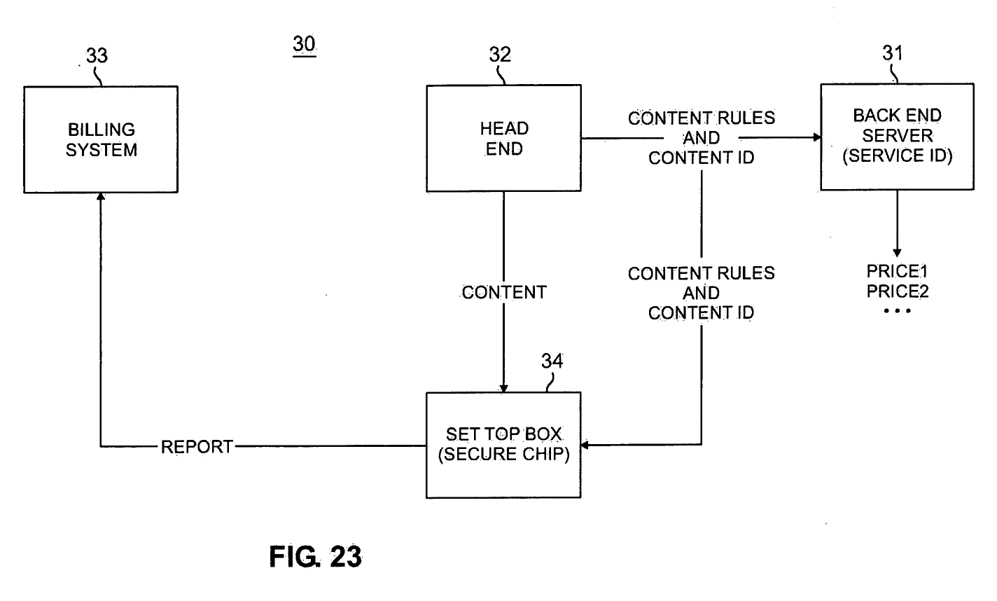

Turning to FIG. 23, shown therein is an exemplary embodiment of an apparatus 30 for distributing protected content to a set top box or other electronic device that includes a secure chip 34. Cable headend 32 stores content being accessed by the set top box 34. Upon access to protected content by the set top box 34, a report is sent to the billing system 33, which bills the user in the normal manner. The secure chip in the set top box 34 decrypts the accessed content in accordance with content rules and informs the billing system 33 as of the type of access and price based on the content rules. A back end server 31 may distribute the price to the user via an electronic program guide or other service in the normal manner. The server 31 receives the content rules from the headend 32 to distribute the pricing. This embodiment has no direct access back to the headend, except for the report sent to the billing system, e.g., via a telephone or other communication channel.

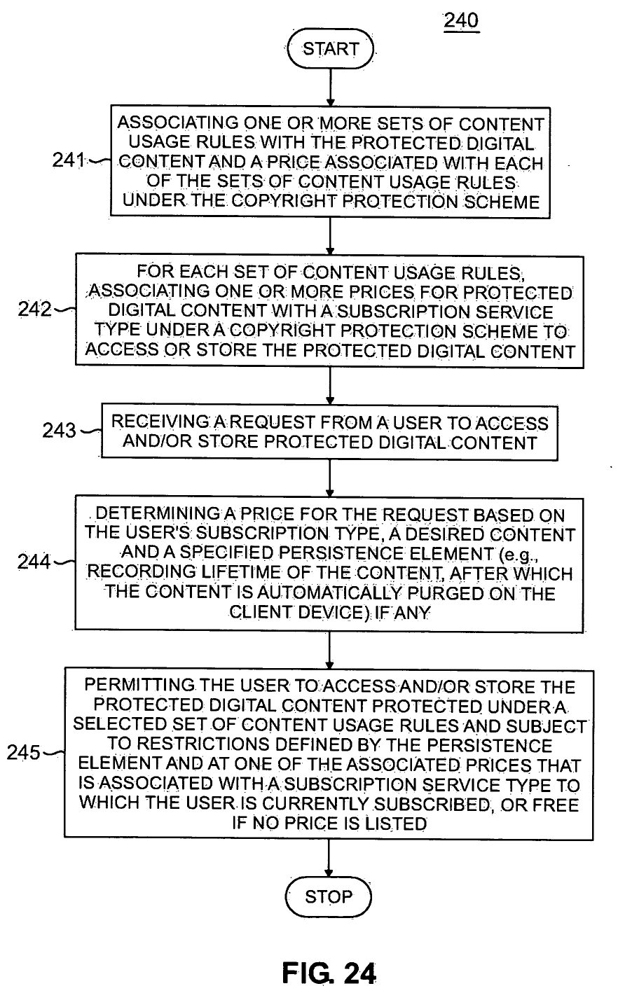

Turning to FIG. 24, shown therein is an exemplary embodiment 240 of a digital rights management method according to another aspect of the present invention.

In element 241, the exemplary embodiment 240 associates one or more sets of content usage rules with the protected digital content and a price associated with each of the sets of content usage rules under the copyright protection scheme.

In element 242, the exemplary embodiment 240 associates one or more prices for protected digital content with a subscription service type under a copyright protection scheme to access or store the protected digital content.

In element 243, the exemplary embodiment 240 receives a request from a user to access and/or store protected digital content.

In element 244, the exemplary embodiment 240 determines a price for the request based on the user's subscription type, a desired content and a specified persistence element (e.g., lifetime of the content, after which the content is automatically purged on the client device) if any.

In element 245, the exemplary embodiment 240 permits the user to access and/or store the protected digital content protected under a selected set of content usage rules and subject to restrictions defined by the persistence element and at one of the associated prices that is associated with a subscription service type to which the user is currently subscribed, or free if no price is listed.

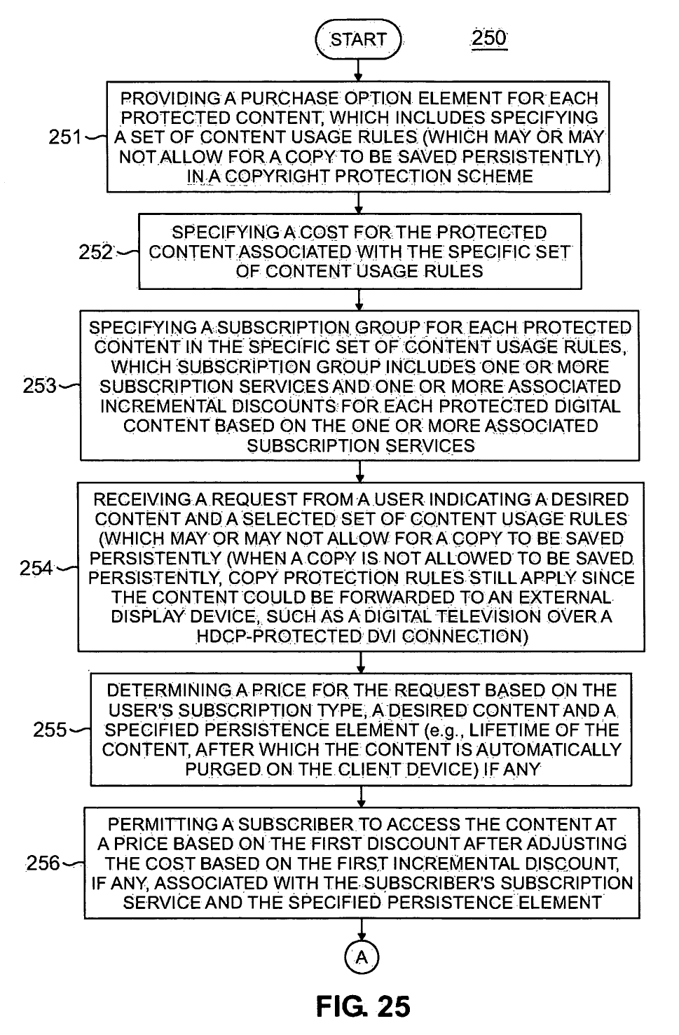

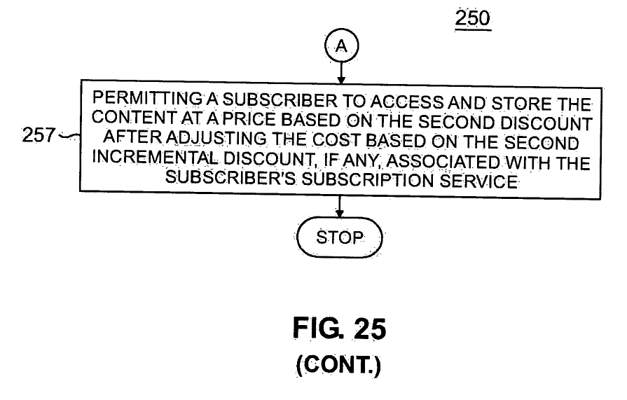

Turning to FIG. 25, shown therein is another exemplary embodiment 250 of a digital rights management method according to yet another aspect of the present invention.

In element 251, the exemplary embodiment 250 provides a purchase option element for each protected content, which includes specifying a set of content usage rules (which may or may not allow for a copy to be saved persistently) in a copyright protection scheme.

In element 252, the exemplary embodiment 250 specifies a cost for the protected content associated with the specific set of content usage rules.

In element 253, the exemplary embodiment 250 specifies a subscription group for each protected content in the specific set of content usage rules, which subscription group includes one or more subscription services and one or more associated incremental discounts for each protected digital content based on the one or more associated subscription services.

In element 254, the exemplary embodiment 250 receives a request from a user indicating a desired content and a selected set of content usage rules (which may or may not allow for a copy to be saved persistently). (When a copy is not allowed to be saved persistently, copy protection rules still apply since the content could be forwarded to an external display device such as a digital Television over a HDCP-protected DVI connection).

In element 255, the exemplary embodiment 250 determines a price for the request based on the user's subscription type, a desired content and a specified persistence element (e.g., lifetime of the content, after which the content is automatically purged on the client device) if any.

In element 256, the exemplary embodiment 250 permits a subscriber to access the content at a price based on the first discount after adjusting the cost based on the first incremental discount, if any, associated with the subscriber's subscription service and the specified persistence element.

In element 257, the exemplary embodiment 250 permits a subscriber to access and store the content at a price based on the second discount after adjusting the cost based on the second incremental discount, if any, associated with the subscriber's subscription service.

Copyright Protection Method

In following, the RuleSet element defined in the Persistent Entitlements XML schema has a “deviceBound” Boolean attribute that when true, indicates that the access device that originally received purchased content is not allowed to make any further copies of the content—not even within the same authorized domain. If this attribute is not set, then further copies may be made within the same authorized domain.

The RuleSet also contains a Redistribution element that specifies an additional set of authorized domains or specific devices with which this content may be shared. It also has a Boolean “move” attribute that when true indicates that the content must be moved (but not copied) between domains.

The RuleSet includes AnalogOutput, DigitalCompressed and DigitalUncompressed elements that specify copy protection rules, which apply only when the content is being sent over an external interface that is not protected by a DRM system. When content is being transferred securely within a DRM-protected domain or between multiple DRM-protected domains, these three elements do not apply but must be preserved without any changes to copy protection states.

The above embodiments have applicability to digital rights management, particularly in IP Set-Top products.

The growing interest in streaming distribution of multimedia content over Internet Protocol (IP) networks brings a need for secure delivery of such content to legitimate customers including all aspects of digital rights management.

The term IP Rights Management (IPRM) encompasses conditional access as well as the various issues surrounding persistent access, defined as access to content after the customer has received and decrypted the content the first time. IPRM, typically referred to as Digital Rights Management (DRM), is essentially the generalization of conditional access technology.

The embodiments of the present invention herein provide XML interfaces that are used by external systems to use services provided by the IPRM system. These XML documents are processed by Caching Servers that deliver content to IPRM clients (Viewers) as well as by the IPRM clients that need to follow copy protection rules for the content that is being rendered and/or persistently stored. The embodiments herein specify XML definitions for all IPRM interfaces requiring XML-based input, specifically content access rights (a.k.a. DRM rules), user selection and user authorization (a.k.a. entitlements).

Definitions and Terminology

Content Provider—An entity that creates, licenses, aggregates and/or distributes content to the Cache Servers but it does not consume content. The Content Provider is also responsible for specifying content access rules and possibly user selection if the user actually makes the purchase at the content provider's web portal. Otherwise, it is made by the Confirmation Server.

Cache Server—An intermediate entity that stores and redistributes content to Consumers and optionally to other Cache Servers. Besides streaming content to viewers, it also enforces the content access rules against the user selection and user entitlements.

Confirmation Server—An application facilitating the creation of a session rights object.

Consumer—An entity such as an end-user that consumes content obtained from a Cache Server and optionally if permitted by the copyright holder, redistributes content to other Consumers in the system. The user is given a set of entitlements by the provisioning center that are used to determine the satisfaction of content access rules. When a user makes a purchase of a specific content, his selection is included in the Session Rights object.

Entitlements—A set of authorization attributes that allow user to access content.

Provisioning Center—An application that registers a new consumer (e.g., Viewer) with the network, provisions it with the Key Distribution Center (KDC) and creates a set of entitlements for the new user.

Session Rights Object—A signed version of content access rules for a given piece of content and specific user's purchase option selection.

Ticket—A token of trust issued to a viewer by the KDC in order to access content at a particular caching server. It also includes the user's entitlements.

Viewer—A consumer for video content.

System Overview

The exemplary embodiment of a IPRM system set forth herein provides digital rights management functions, such as authentication, privacy, security, integrity, access control tools to any multimedia streaming network based on Internet Protocols. The system supports point-to-point video on demand (VOD) and multicast delivery of content. Additional features relate to persistent content rights management, such as copy protection.

An exemplary embodiment of the present invention is initially based purely on software protection, with a limited trust placed upon the clients. This embodiment can be enhanced with an optional hardware security module, which may be mandatory to obtain rights to high quality content from copyright owners requiring high security levels.

The Session rights XML document is generated by the content provider or any other entity (e.g., a Confirmation Server) that provides the final interaction with the end-user. The content of the Session Rights document is encoded in the Session Rights Object (SRO) object.

The Authorization XML document is maintained by the Provisioning Server and is included in each ticket given to an end-user by the KDC. The Rights Manager module on the Caching Server evaluates the rules and user selection against the authorization data in the ticket to allow or disallow access to the specified content.

XML Element Description

Each XML document consists of a root element and a set of nested elements. The following sections describe the structure and use of the IPRM XML schemas: Session Rights, Authorization Data, Persistent Entitlements and Copy Protection Rules.

Session Rights Definition

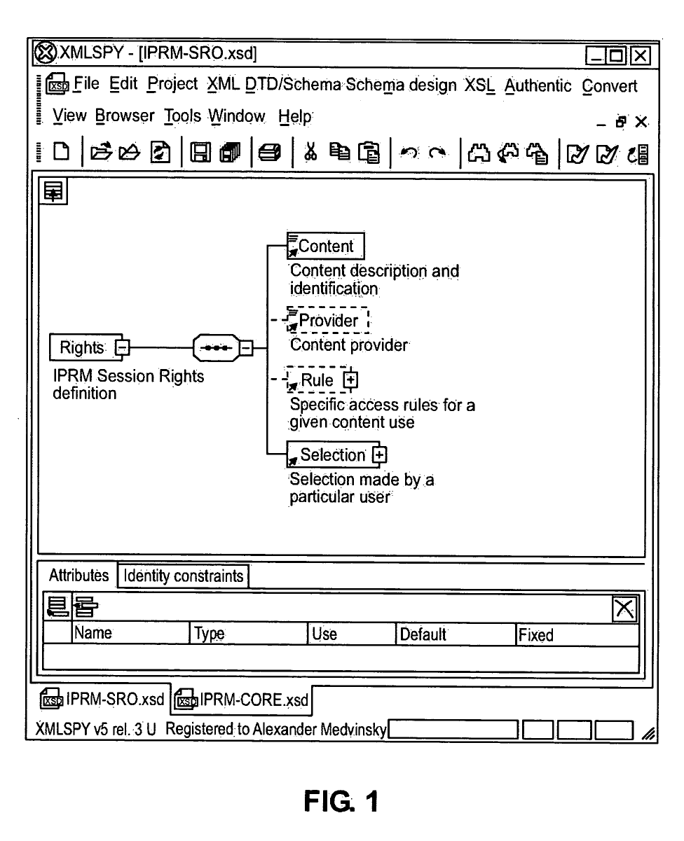

The Rights element is the root element of the Session Rights document. It is a sequence of two required elements: Content and Selection and two optional elements: Provider and Rule. FIG. 1 depicts a block diagram of the Session Rights Element.

The Content element uniquely identifies the content associated with this set of session rights. Attribute “format” specifies in what format the content identification is specified (e.g., URL, ISBN, etc.) with URL being the default. The “id” attribute specifies the unique content identifier. When the ‘protected’ is ‘Y’ (which is the default), the associated content is encrypted both during the pre-encryption phase and when it is delivered to a consumer. Otherwise, the associated content is unprotected.

The Provider element optionally specifies the ProviderID (“pid” attribute) and the provider name as a text string.

The Rule element specifies a set of rules associated with the associated content specified in the “Content” element.

The “extern” attribute specifies whether the rules are defined in this document (value “false”) or in an external document (value “true”). The default value is “false.” The rules however do not change often and can be cached for instance at a Caching Server where the user can retrieve protected content. This would significantly reduce the size of each Session Rights Object (SRO).

The Selection element specifies the purchase selection the user, on whose behalf this Session Rights document is presented, has made.

The “optionID” attribute identifies a particular PurchaseOption defined within the Rule element that was selected by the user. Each option may be associated with different copy protection rules for persistent or non-persistent content.

The “extern” attribute specifies whether the selection is defined in this document (value “false”) or in an external document (value “true”). The default value is “false.”

When the “deviceBound” attribute is set to “Y”, the content will not be shared outside the access device. If it is set to “N”, then the content will be shared across user's authorized domain. If this attribute is not specified, need to check persistent entitlements to find out. This attribute affects how blackout verification is performed. If the content is not shared outside the access device, then the blackout check only applies to the locations (listed inside Authorization Data) that have the “AccessPoint” attribute set to “Y”. Otherwise, all locations listed in Authorization Data need to be checked. The value of this attribute must be consistent with the persistent entitlements that are associated with the user selection.

Rule Element

The Rule element specifies all access rules associated with the specified content. It is a choice of one or more of the available rules. If the Rule element is not specified, it is assumed that the content:
Is free;
Not blacked out anywhere;
Has no rating associated with it;
Not available for subscription;
No particular level of security is required to access it.

In order to get access to such content, the Purchase element in the user Selection must be set to FREE.

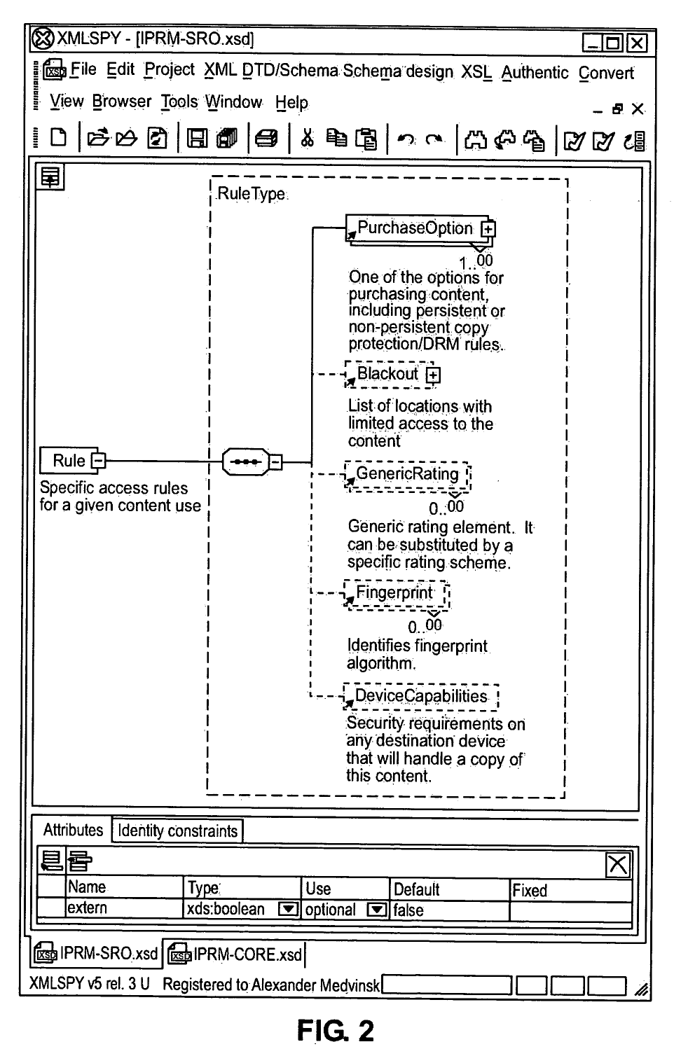

FIG. 2 depicts the Rule Element in block diagram format.

The PurchaseOption element defines copy protection rules or DRM rules for persistent data associated with a specific option for purchasing this content. This option is also associated with a price and a list of subscription service under which this option may be selected for free or at a decreased cost. Multiple PurchaseOption elements may be included to indicate different options for the user to purchase the content. Some of the options may restrict the purchase to only initial rendering of the content, while other options may allow the user to save a copy of the content with varying DRM rules.

The “optionID” of the Selection element specifies the ID of the purchase option that was selected by the user. Typically, if an Origin Server generated a full set of Session Rights with both rules and user selection, there would only be a single PurchaseOption element included in the rules, which is the one selected by the user (in order not to waste bandwidth). But if the Origin Server generates only the user selection while rules are cached on a Caching Server, the rules would typically include all PurchaseOption elements associated with this content.

The Blackout element provides a mechanism to restrict access to the given content geographically. It provides the ability to define an area specified by a list of country codes or other types of location specifiers where the content is or is not allowed. This rule will be evaluated against the list of LocationGroups in the Authorization Data document.

The GenericRating element specifies the content rating level for a particular rating scale or standard (e.g., MPAA rating, TV rating, etc.). This element can be repeated multiple times in order to define the rating levels for multiple rating scales. This rule will be evaluated against the GenericRating element in the Authorization Data document representing the user-rating ceiling where the ceiling must be equal or higher than the content rating. This rule can be overridden by the Override element in the Selection element.

The Fingerprint elements specify a list of fingerprint algorithms that may be applied to the content that is being sent to a client. If at least one such element is present, one of these fingerprint algorithms must be applied by the streaming server.

The DeviceCapabilities element specifies security requirements for a consumer device receiving this content. Some of these security requirements apply to content rendering, while others apply when a device makes a persistent copy of the content.

Requirements for rendering:
securityLevelToRender attribute is the minimum security level of the content rendering device.
codecInSecureHW attribute is a flag that when true (“Y”) requires a rendering device to decompress content inside secure hardware.
WatermarkInSecureHW attribute is a flag that when true (“Y”) requires a rendering device to perform watermark detection inside secure hardware.
FingerprintInSecureHW attribute is a flag that when true (“Y”) requires a rendering device to insert a fingerprint inside secure hardware.

Requirements for copying:
SecurityLevelToCopy attribute is the minimum security level of the destination device that is getting a persistent copy of the content.

This rule will be evaluated against the SecurityLevel attribute of the client ticket.

PurchaseOption Element

One or more of the PurchaseOption elements are included in the Rule element.

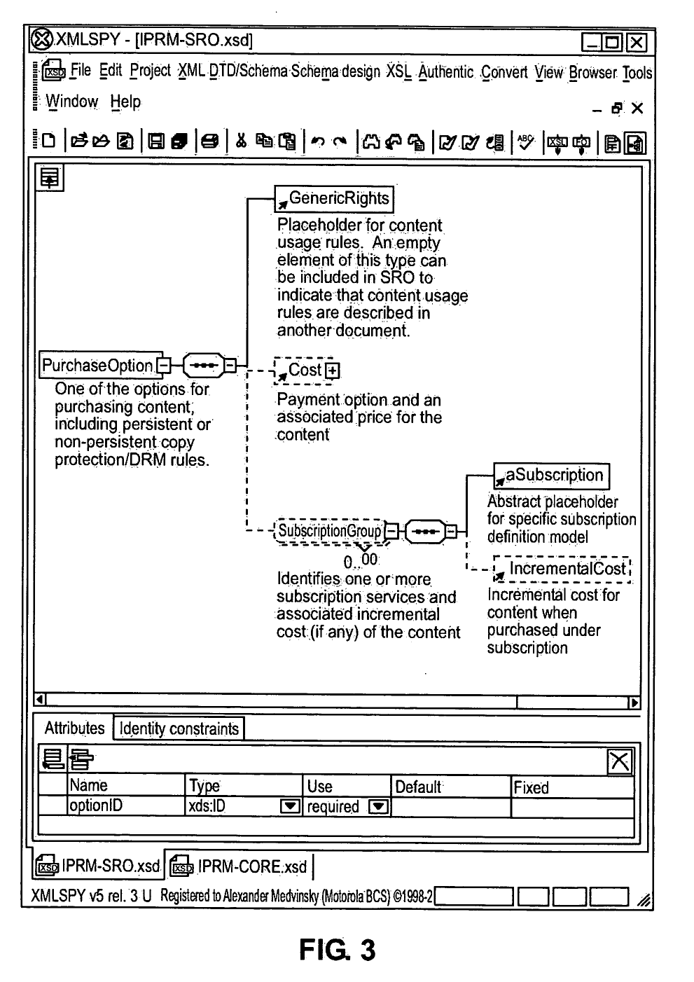

The PurchaseOption element is illustrated in FIG. 3.

GenericRights element has no type when directly present and indicates that the actual copy protection rules or rights associated with persistent content are specified in a different XML document. This element is also a substitution group and the substitution elements may be:
CopyProtectionRules—defines copy protection rules associated with the content that is not saved persistently but could be forwarded to various digital and analog outputs. This element is defined in a separate XML schema, see section below.
PersistentEntitlements—content usage rules associated with a persistent copy of the content. The presence of this element indicates that the content will either be downloaded or recorded by a client device during a streaming session. This element is defined in a separate XML schema, see below.

Cost element specifies the price of the content. The “currency” attribute specifies the currency expressed as a 3-letter acronym defined by ISO 4217. US dollar is the default value. If a different currency representation is needed in the future, the “format” attribute can be used to specify other formats. This element is not applicable when content is made available on subscription basis only.

If the Cost element is not specified, the content cannot be purchased and may be available for subscription. If the Subscription element is not specified either, the content is assumed to be FREE.

The nested elements specify different ways to buy the content.

The OneTimePay element specifies the price for the pay-per-view purchase mechanism. The “price” attribute specifies the cost for accessing this content.

The PBT element provides a mechanism to purchase content at time increments.

The “increment” attribute specifies the time interval (in minutes) the “price” is associated with. For instance, if the “price” is 0.95 cents and the increment value is 30, the user will be charged 0.95 cents for each 30 minutes that she views the content.

This rule will be checked against the Payment element in the Selection element and evaluated against the Pay element in the Authorization Data document representing the user ability to pay for content. Table 1 below defines the relationship between elements of the PurchaseOption (in columns) and user Selection (in rows).

| | Subscrip- | Cost- | | | |
|---|---|---|---|---|---|
| Rule & | tion | OneTime- | Cost- | Nei- | Authoriza- |
| Selection | Group | Pay | PBT | ther | tion: Pay |
| SUBSCR | YES | N/A | N/A | DENIED | Depends |
| | | | | | (see below) |
| OneTimePay | N/A | YES | N/A | DENIED | INDIVIDUAL |
| PBT | N/A | N/A | YES | DENIED | INDIVIDUAL |
| FREE | NO | NO | NO | YES | N/A |

When a particular value of Selection is present, value YES specifies that the element of PurchaseOption in that column must be present and will be evaluated; value N/A specifies that the corresponding element may be present but will not be used for evaluating access rights; value NO means that the rule must not be present; value DENIED means that access will be denied. In addition, the most right column shows the required value of the Pay element from the user authorization.

In the case that the Payment element of the user selection is set to SUBSCR, the selected PurchaseOption must contain one or more SubscriptionGroups. If there is at least one matching SubscriptionGroup without an IncrementalCost element, then the Pay element in the user selection will be ignored. Otherwise, the value of the Pay element must be INDIVIDUAL.

If none of the Subscription or Cost rules is specified, the content can be accessed only if the user Selection is set to FREE.

SubscriptionGroup includes the following two elements:
aSubscription element specifies a list of services on which this piece of content is available for subscription. This element is described in more detail below. This rule will be evaluated against the list of aSubscription elements in the Authorization Data document if the user selects the “SUBSCR” purchase option. If the user has at least one of the provider/service pairs in his entitlements, he will be granted access to the service (assuming that other rules, such as blackout and rating, are satisfied as well).
IncrementalCost optional element is associated with a particular aSubscription element and indicates that there is still an amount that needs to be paid when the content is obtained through a subscription to one of the specified services. The “currency” and “format” attributes are the same as the “currency” and “format” attributes for the Cost element of the PurchaseOption. The “price” attribute specifies the (possibly reduced) cost for the content when it is obtained through this subscription.
   aSubscription Element

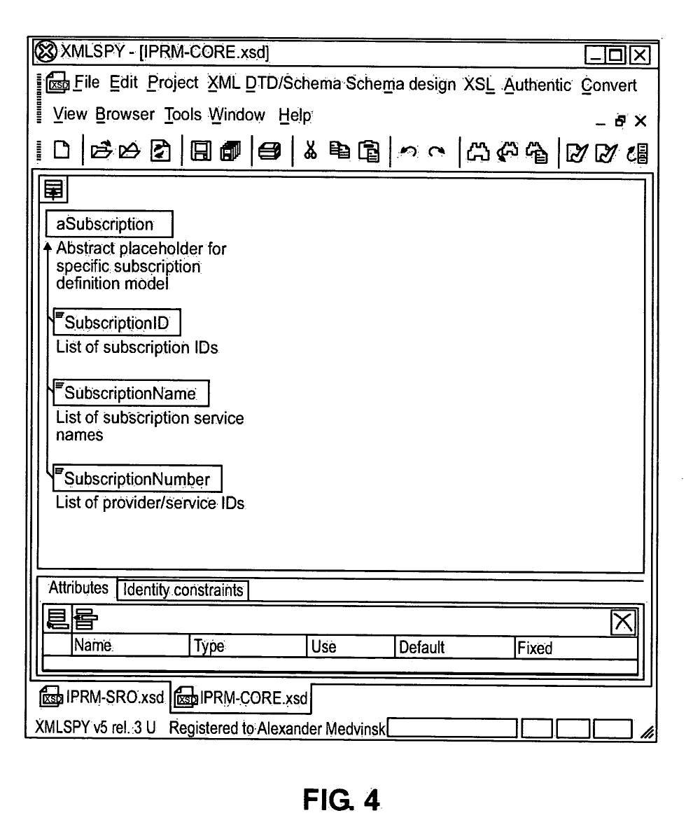

aSubscription element specifies a list of services on which this piece of content is available for subscription and is illustrated in FIG. 4.

Because there are multiple methods for identifying service providers and services, aSubscription is an abstract placeholder for a specific subscription element. The substitution elements for aSubscription are:
SubscriptionID—a list of 2-byte unsigned integers representing service identifiers. This element also has an optional “provider” attribute that is a 2-byte unsigned integer that identifies a provider. The reason that provider is optional is because in some cases service identifiers may be globally unique and may already imply a specific service provider.
SubscriptionName—a list of service names separated by white space. Each name may not itself contain white space. This element also has an optional “provider” attribute that is the provider name (with no white space characters). In the case that service names are globally unique or already imply a specific provider, the provider attribute may be omitted.
SubscriptionNumber—a list of concatenated provider and service identifiers (2 bytes for provider, 2 bytes for service).
   Blackout Element

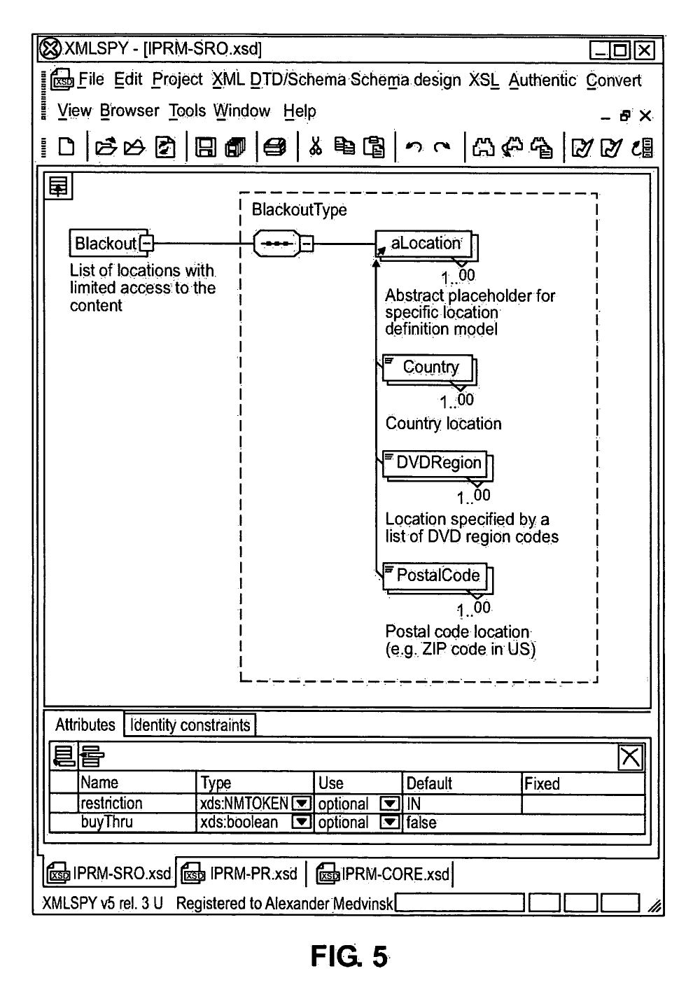

The Blackout element is a sequence of locations where the content may or may not be viewed (depending on the value of the “restriction” attribute described below), as illustrated in FIG. 5.

The “restriction” attribute specifies whether the content is blacked out (i.e., isallowed) inside the specified geographic area (value IN) or outside of the area (value OUT). The “buyThru” attribute specifies whether the content can be purchased when the user would be otherwise blackout out. This is useful for content distributed on subscription basis.

Each element of the Blackout sequence is a substitution group, needed to accommodate different types of location codes. The element aLocation is an abstract placeholder for a specific location element. The substitution elements for aLocation are:
Country—a list of tokens separated by white space, where each token identifies a country as a two-character country code defined in “ISO3166” (the default value of the “format” attribute—other formats may be supported in the future).
DVDRegion—location specified by a list of DVD region codes separated by white space. The possible region codes are:
1=U.S., Canada, U.S. Territories
2=Japan, Europe, South Africa, and Middle East (including Egypt)
3=Southeast Asia and East Asia (including Hong Kong)
4=Australia, New Zealand, Pacific Islands, Central America, Mexico, South America and the Caribbean
5=Eastern Europe (Former Soviet Union), Indian subcontinent, Africa, North Korea and Mongolia
6=Peoples Republic of China
7=Reserved
8=Special international venues (airplanes, cruise ships, etc.)
PostalCode—a list of tokens separated by white space, where each token is a postal code location (e.g. ZIP code in US).

It has an optional boolean attribute “long” that specifies if the postal code is expressed in long form (e.g., 9-digit US ZIP code instead of a 5-digit one). If this attribute is not present, the short form is assumed.

An optional “country” attribute specifies a country within which the postal codes are located. If the country is not specified, US is assumed. There is also an accompanying optional “format” attribute that specifies the type of the country code used in the value of the “country” attribute. The default value for “format” is “ISO3166”.

GenericRating Element

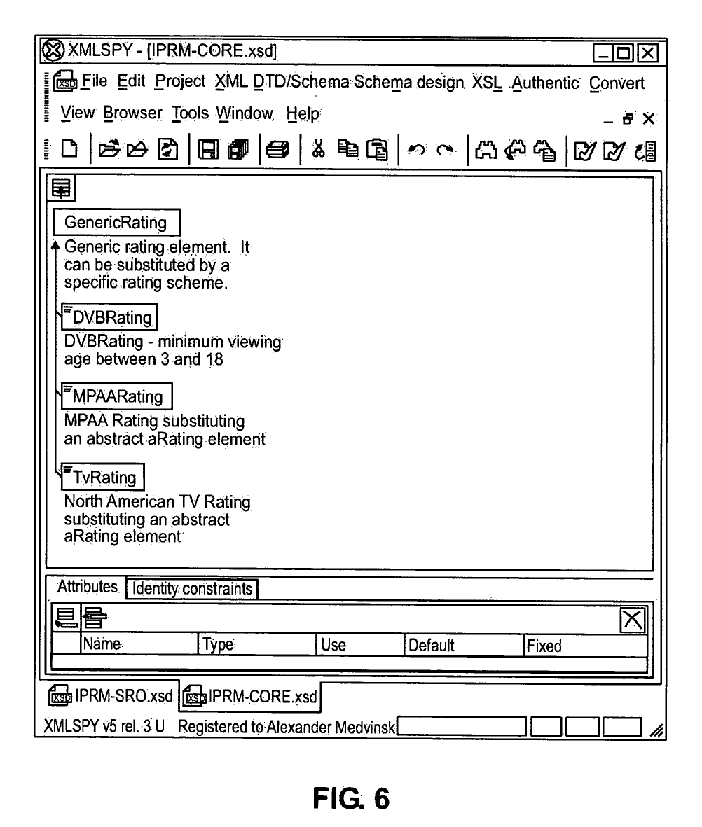

The GenericRating element specifies a content rating as illustrated in FIG. 6. GenericRating element is of type NMTOKEN and has the following possible values:
LEVEL0, LEVEL1, LEVEL2, LEVEL3, LEVEL4, LEVEL5

GenericRating may be used as a custom content rating scale where the meaning of each level is the same in both the Session Rights and in the Authorization Data XML documents. Because there are multiple rating scales, GenericRating is also a substitution group. The substitution elements for GenericRating are:
DVBRating—a positive integer between 3 and 18 that represents a minimum allowable age of the viewer.
MPAARating—a string with no white space that represents one of the MPAA rating levels.
TvRating—a string with no white space that represents one of the North American TV rating levels.

It is possible to have multiple content rating elements in both Session Rights and Authorization Data XML documents. In that case, one has to compare pairs of content rating elements from Session Rights and Authorization Data that are of the same type. For example, MPAARating element in Session Rights would be compared to an MPAARating element in Authorization Data. If the rating ceiling set in Authorization Data is not exceeded for every such pair of rating elements, then the content rating check passes. If both Session Rights and Authorization Data have content rating elements but none of them have matching types, then the content rating check passes as well.

Selection Element

The Selection element specifies user selection related to the consumption or purchase of the selected content. It is a sequence of the following elements.

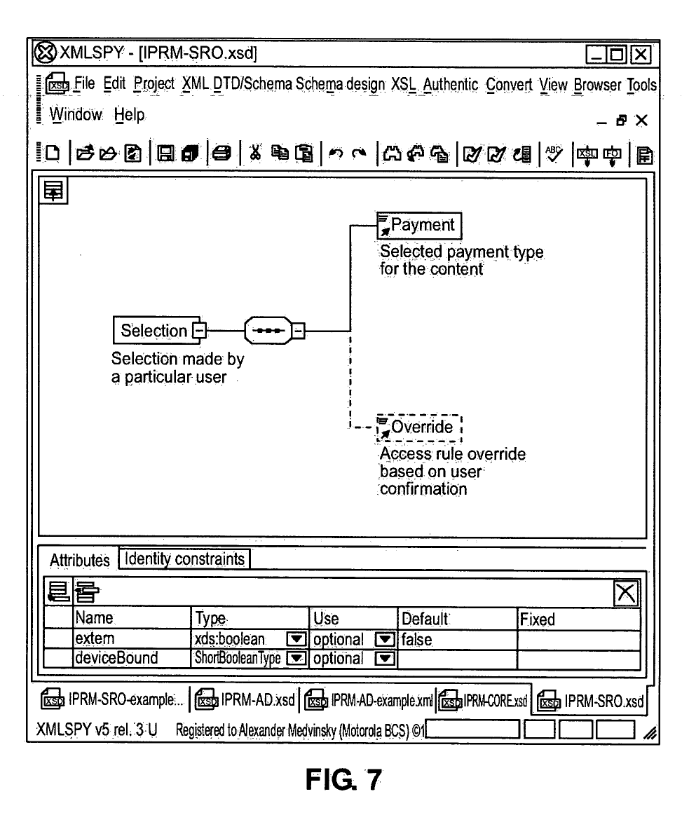

FIG. 7 depicts a Selection Element.

Purchase element specifies the purchase option the user has selected in order to obtain access to the content. The following values are defined:
FREE—the content is free
SUBSCR—the user has a subscription to the service
ONE-TIME-PAY—the user selected the option to buy the content based on a single payment (no subscription)
PBT—the user selected the option to buy the content on pay-by-time basis

Override element specifies whether the user has overridden his rating ceiling when he ordered the content (e.g. provided a password or PIN code to the purchase or confirmation server). The value of this element specifies what rule was overridden, meaning that the rule is not going to be enforced. RATING is the only value currently supported.

Authorization Data Definition

The Authorization element is the root element of the User Authorization Data document. It is a sequence of several optional elements: purchasing capability (Pay element), user location (Country element), user subscription (Subscr and SubscrList elements), content rating ceiling (Rating element) and an element of type “any”.

The Authorization element has several attributes:
principal—a unique identifier of an end-user client who is requesting the specified content. This attribute is required so that it can be used for billing purposes, for instance.
operator—an optional attribute identifying the network provider (MSO, ISP, etc.) of the end-user identified by the principal name above.

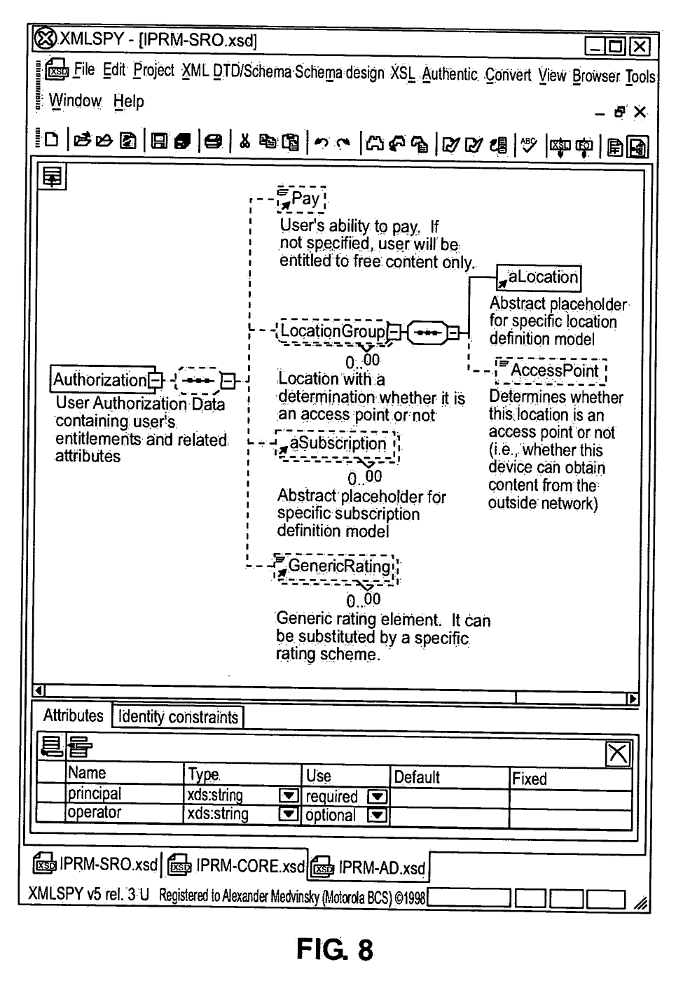

FIG. 8 depicts the User Authorization Element.

Pay element specifies users ability to pay for content. The following values for the “type” attribute are defined:
INDIVIDUAL—User is allowed to pay for individual content (e.g. PPV or PBT) LocationGroup includes aLocation element that specifies the location of the user, which is used to evaluate blackout rules. This is an abstract placeholder for elements that identify a specific type of location (such as country or zip code). For detailed description of this element, see below (where aLocation is described as a component of the Blackout element).

There is also an optional AccessPoint element that when true (“Y”), indicates that this is the location of an access point that initially obtains the content after the content purchase. If this element is false (“N”), then this is the location of a segment of the user's personal network and applies when the user purchased content with the rights to keep a persistent copy and render it on any device within the user's personal network. The default value is “Y”.

When checking if a blackout applies to a user for view-only content, only LocationGroups with AccessPoint set to true (or not present) need to be checked. On the other hand, for content that is to be saved persistently and shared within the user's personal network, all LocationGroups need to be checked.

If no LocationGroup is provided, the blackout rules are evaluated as if the user were located everywhere meaning that the user will always be blacked out if blackout rules are specified.

aSubscription element specifies a service or a list of subscription services provided by a given service provider. It is an abstract substitution element that allows for the services and service providers to be identified using different conventions.

GenericRating element specifies the user-selected content rating ceiling, i.e., the highest level of rating allowed for a given rating dimension. This is an abstract substitution element that allows different rating methods to be used. Authorization for the same user can have multiple GenericRating elements in order to convey the rating ceilings for multiple content rating methods.

Persistent Entitlements Definition

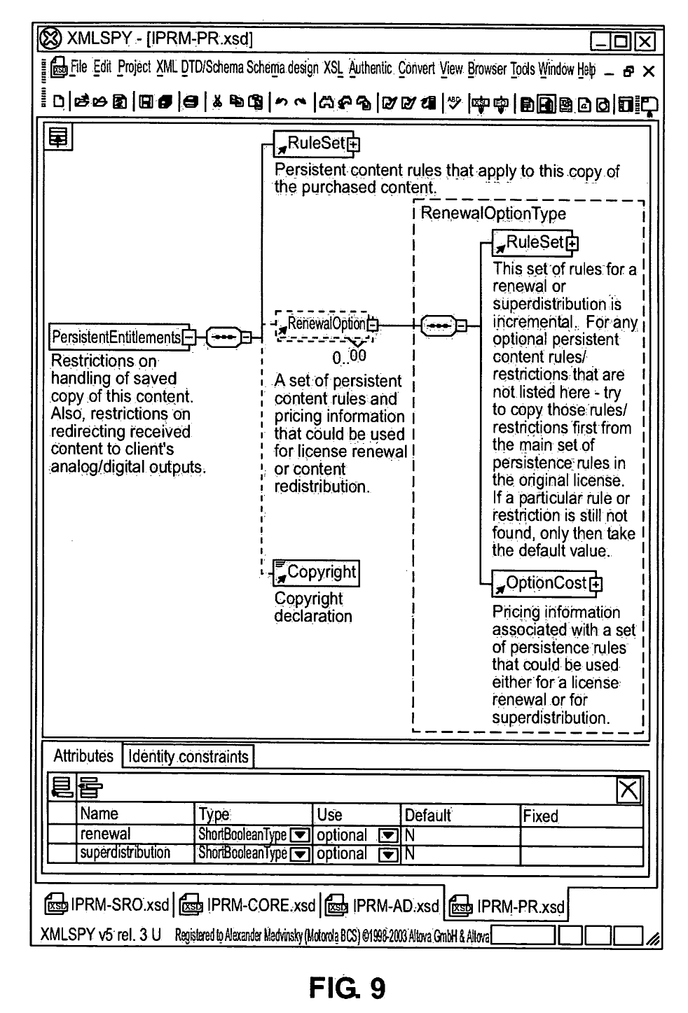

The PersistentEntitlements element is the root element of the IPRM Persistent Rights schema. It can either be utilized as a separate XML document that is included inside the SRO along with the Session Rights document, or it can be included directly inside the Session Rights as part of one of the PurchaseOption elements (see section 3.1.1.1). It is illustrated in the FIG. 9.

PersistentEntitlements contains the following attributes:
renewal—if ‘Y’, this license may be renewed after it expires. In other words, a request may be sent to a License Server to obtain a new license for already stored content. The rules that would appear in a new license after a renewal can be either taken from one of the renewal options (see below) or a new set of rules can be obtained (inside an SRO) from an Origin Server.
superdistribution—if ‘Y’, the corresponding content may be superdistributed to other users (which would still have to pay in order to get a valid license for the content). The rules that would appear in a new license associated with a superdistributed copy of the content can be either taken from one of the renewal options (see below) or a new set of rules can be obtained (inside an SRO) from an Origin Server.

PersistentEntitlements is also a sequence of the following elements:
RuleSet element is a set of content usage rules and restrictions associated with the content.
RenewalOption elements. When the Renewal attribute is set for PersistentEntitlements, each RenewalOption represents a possible set of rules that would go into a new license after a renewal. A RenewalOption also includes a cost—an amount of money that would be charged to a consumer for renewing a content license with this option.

A RuleSet element of the RenewalOption has the same type as the RuleSet element of the PersistentEntitlements. However, in this case the RuleSet represents incremental changes from the original set of rules. When a renewal option is selected, the resulting set of content rules/restrictions is obtained as follows:
a) If a particular rule or restriction is found only in the original (base) RuleSet, copy it into the new PersistentEntitlements.
b) If a particular rule or restriction is found only in the RuleSet for the selected renewal option, copy it into the new PersistentEntitlements.
c) If a particular rule or restriction is found in both the base RuleSet and in the RuleSet for the renewal option, take the one in the renewal option.
d) If a particular rule or restriction is found in neither of the two rule sets, use a default value.

The OptionCost element of the RenewalOption contains both the cost for license renewal using this option and a cost of superdistribution using this option (that may be different from the renewal cost). For more detailed description of OptionCost, see section 3.3.2.

Copyright element is the copyright information associated with the content.

RuleSet Element

The RuleSet element specifies all the rules associated with the specified persistently stored content. (The identity of the content, e.g., a URI, is not present inside the RulesSet or inside the PersistentEntitlements. The content identity is generally a separate parameter that accompanies the PersistentEntitlements XML document (e.g., a separate TLV parameter inside Persistent Data Entitlements DOI object).

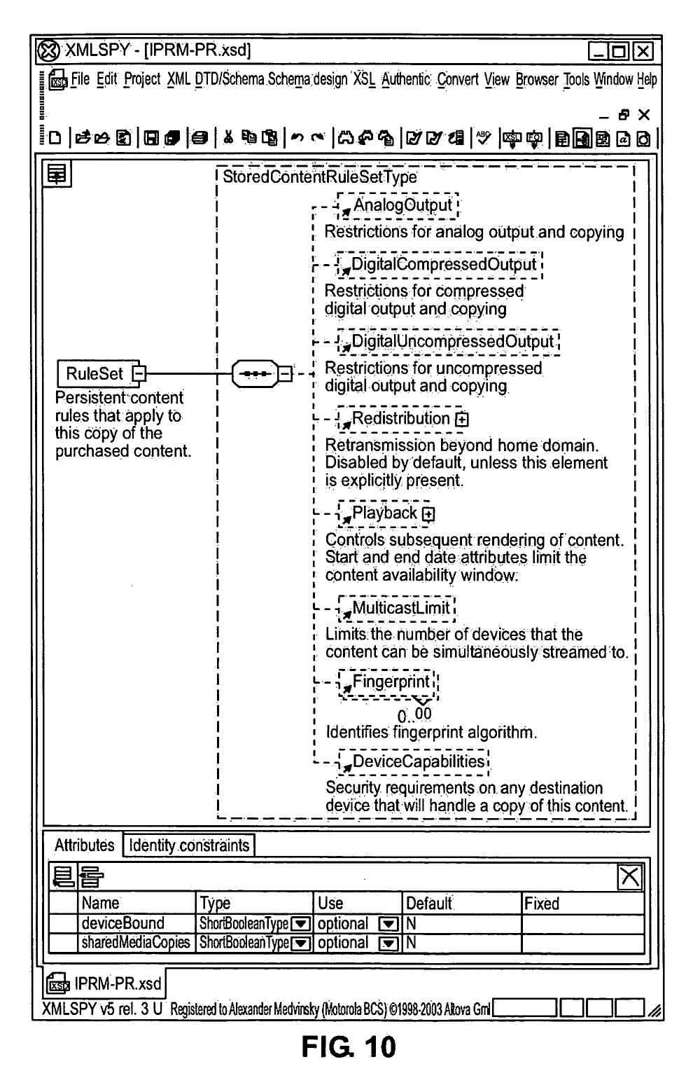

FIG. 10 depicts the RuleSet Element.

A RuleSet element contains the deviceBound attribute, which is a boolean flag that when set to “Y” means that once a Viewer saves a copy of this content, no further copies of the content may be made, even within the same authorized domain (user's personal network) protected by IPRM security.

RuleSet also includes the sharedMediaCopies attribute, which is a boolean flag that when set to “Y” allows copies of this content to be made on shared removable media. A single copy of the content on a shared removable media can be played on any device within the same authorized domain. However, if “deviceBound” attribute is “Y”, copies of the content on shared removable media are not allowed even when “sharedMediaCopies” attribute is “Y”.

RuleSet is of type StoredContentRuleSetType, which is a sequence with each element described in the following subsections.

AnalogOutput

This element restricts copies over an analog interface. It can also define MACROVISION parameters, where MACROVISION is a mechanism to prevent analog copies of a video signal and would normally be used when the ‘copyRestriction’ attribute defined below is set to NOCOPY (i.e., analog copies are not allowed).

Today, within most of commercially available devices no such equivalent exists for analog audio. Therefore, in most cases when ‘copyRestriction’ for analog is set to NOCOPY for an audio-only (e.g., music) content, analog output has to be completely disabled.

AnalogOutput consists of the following attributes which are apply specifically to analog output:
copyRestriction—an enumeration type that specifies a copy protection state associated with analog interfaces. The IPRM system must ignore (but still preserve) this attribute except in the case when it is exporting content over an analog interface. In that case, the IPRM system must translate this copy protection state to whatever means are available on the particular analog interface, including CGMS-A and MACROVISION. This attribute can have one of the following values:
UNLIMITED—no limitation on the number of copies of the content that is received over an analog interface.
NOCOPY—copying of the content received over an analog interface is not permitted. In practice this means that when content is transmitted over an analog interface, MACROVISION must be turned on. Some analog video interfaces also support CGMS-A copy protection bits inside VBI.
NOMORE—no more copies of this content may be made over an analog interface. One way that IPRM-controlled content could get this setting is during the following scenario:
   The content is imported into the IPRM system over an analog interface.
   This analog interface carries CGMS-A copy protection bits over VBI.
   The CGMS-A relayed over the analog interface was set to ONEGENERATION.
   Therefore, when the IPRM system imports this content, it is obligated to transition the copy protection state from ONEGENERATION to NOMORE.
ONEGENERATION—only a single copy of the content received over an analog interface may be made. When that copy is made, the copy protection state must be changed to NOMORE. It may be possible to relay this copy protection state over some analog interfaces using CGMS-A over VBI.
numberOfCopies—this attribute is applicable only when copyRestriction attribute is set to ONEGENERATION. In that case, this attribute specifies how many ONEGENERATION copies of the content may be made over an analog interface. The value of 0 (or if numberOfCopies attribute is not present) means that there is no limit on the number of ONEGENERATION copies made. The maximum value of this attribute is 3.
componentOutput—a boolean flag. When set to ‘Y’, it is OK to transmit this content over a component analog output.
outputAllowed—a boolean flag. When set to ‘N’, analog output of any type for this content is disabled. Note that ExCCI doesn't have this option—it only disables component (video) output. But component output does not apply to audio-only content, in which case this attribute may be used instead.
pseudoSyncPulse—a boolean flag. When set to ‘Y’, MACROVISION must utilize a Pseudo Sync Pulse (PSP).
splitColorBurst—an enumeration type that can have the following values:
   N—split color burst not utilized by MACROVISION
   2—use 2-line split color burst for MACROVISION
   4—use 4-line split color burst for MACROVISION
constrainedImage—limits a video image resolution on an analog output. When set to 0, there is no restriction on resolution. When set to 1, an application generating an analog output will decide how to restrict the video image resolution. Otherwise, this attribute specifies a limit on a number of pixels per frame (e.g., in ExCCI, a constrained video image is limited to 520,000 pixels per frame).
constrainedAudio—limits audio bit rate on an analog output. When set to 0, there is no restriction on audio bit rate. When set to 1, an application generating an analog output will decide how to restrict the audio bit rate. Otherwise, this attribute specifies a limit on the bit rate in KBits/sec for analog audio output.
audioChannelLimit—limits the number of audio channels for analog output. When set to 0, there is no restriction on the number of audio channels. Otherwise, this attribute specifies a limit on the number of audio channels (e.g., if the limit is 2, a surround sound audio signal has to be converted to stereo with only 2 channels).
   DigitalCompressedOutput

This element restricts copies over an external digital compressed interface that is not protected with the IPRM system. An example of such an interface would be IEEE-1394 (Firewire bus). However, if there is an IP stack running on top of IEEE-1394 and IPRM is used to protect content over this interface, this element would be ignored.

DigitalCompressedOutput consists of the following attributes:
copyRestriction—an enumeration type that restricts the number of copies of the content that may be made over an external digital compressed interface. The values of this attribute are defined above. This attribute does not apply (but must be preserved) when content is exchanged between devices in the same authorized domain using IPRM security. When content is transferred over an external digital compressed interface, this copy protection state must be translated (e.g., to CGMS-D) and sent over the specific digital compressed interface.
numberOfCopies—this attribute is applicable only when copyRestriction attribute is set to ONEGENERATION. In that case, this attribute specifies how many ONEGENERATION copies of the content may be made over an external digital compressed interface. The value of 0 (or if numberOfCopies attribute is not present) means that there is no limit on the number of ONEGENERATION copies made. The maximum value of this attribute is 3.
outputAllowed—when this boolean flag is set to ‘N’, digital compressed content must not be sent over external interfaces even when they are encrypted using a non-IPRM copy protection technology (e.g., 5C). This flag applies when content is sent with an intent to copy as well as when the content is sent with an intent to render-only.
   DigitalUncompressedOutput

This element restricts copies of the content that is received over an external digital uncompressed interface (e.g., DVI) that is not protected with IPRM. This element consists of the following attributes:
copyRestriction—an enumeration type that restricts the number of copies of the content received over an external digital uncompressed interface. The values of this attribute are defined above. This attribute does not apply (but must be preserved) when content is exchanged between devices in the same authorized domain using IPRM security. When content is transferred over an external digital uncompressed interface, this copy protection state must be translated (e.g., to CGMS-D) and sent over the specific digital uncompressed interface.
numberOfCopies—this attribute is applicable only when copyRestriction attribute is set to ONEGENERATION. In that case, this attribute specifies how many ONEGENERATION copies of the content may be made over an external digital uncompressed interface. The value of 0 (or if numberOfCopies attribute is not present) means that there is no limit on the number of ONEGENERATION copies made. The maximum value of this attribute is 3.
outputAllowed—when this boolean flag is set to ‘N’, digital uncompressed content must not be sent over external interfaces even when they are encrypted (e.g., with HDCP). This flag applies when content is sent with an intent to copy as well as when the content is sent with an intent to render-only.
   Redistribution

This element defines rules for retransmission of the content beyond the current authorized domain. Note that this element does not apply to superdistribution where a copy of the content is sent to another consumer (in a new authorized domain) without any rights to use the content. This element is used in the cases when an initial set of persistent content entitlements already allows the content to be lawfully shared between multiple authorized domains without an additional cost.

This element has the following attribute:
contentOperation—defines how the content is to be consumed by a particular destination. The list of authorized domains to which the content may be streamed, moved or copied can be optionally restricted—see below. This is an enum-valued attribute that can take on the following values:
STREAM—This allows you to only stream the content to a particular destination. The content may not be recorded, copied or moved.
MOVE—This allows you to either stream the content to a destination, or move the content. A move means that as soon as a copy or recording of the content is made at the destination, the original copy must be removed. In the case of a move, all copies of the content in the original authorized domain must be removed.
COPY—This allows the content to be streamed, recorded, moved or copied to a destination.

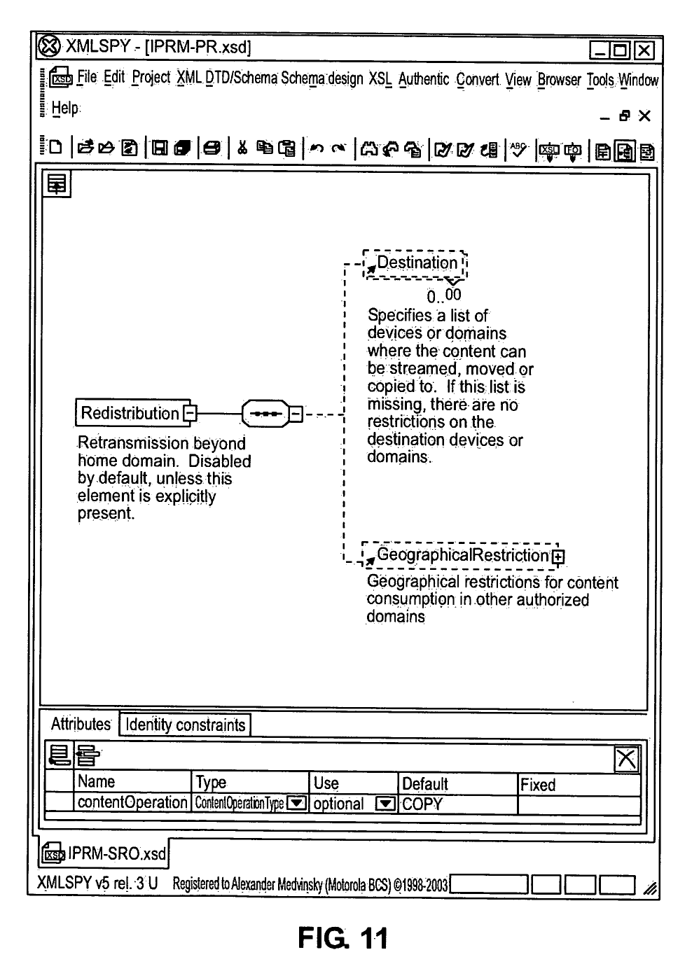

The Redistribution element is illustrated in FIG. 11.

Redistribution element includes a sequence of 0 or more Destination elements, where each destination element allows the content to be copied, moved or streamed (as specified by the “contentOperation” attribute) to that specific destination that is outside of the current authorized domain.

A Destination element contains the following attributes:
realm—identifies another authorized domain to which the content can be copied, moved or streamed. In the case of an IPRM system that utilizes the ESBroker key management protocol, this parameter is identical to an ESBroker realm for that authorized domain.
id—a host identifier for a specific device in the specified authorized domain to where the content may be copied or moved. If this parameter is not included, the content may be copied, moved or streamed to any device in the specified authorized domain.

Redistribution element can also optionally include a GeographicalRestriction element that might prevent streaming, movement or copying of content into authorized domains listed in Destination elements if they are located in blacked out geographical regions. This is the same as the Blackout element described herein, except that there is no “buyThru” attribute in this case.

Playback

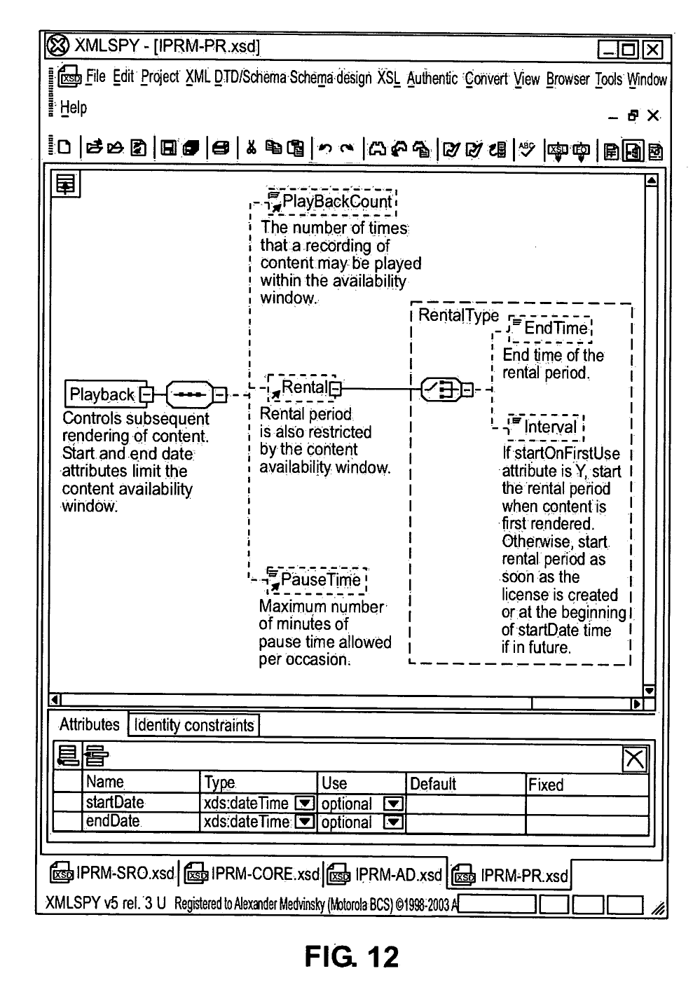

The Playback element places restrictions on playback of stored content. It defines conditions which determine when stored content becomes expired and may no longer be used. The Playback element is illustrated in FIG. 12.

A Playback element has the following attributes (both optional):
startDate—the content cannot be accessed before this time.
endDate—the content cannot be accessed after this time.

A Playback element is a sequence of one or more of the following elements:
PlayBackCount—it is an integer value that specifies the maximum number of times that this content may be played back before it is considered to be expired. This element has an optional attribute maxDuration that limits the duration of each individual play back. When maxDuration is specified, a playback must be automatically terminated after the specified time period. The startDate and endDate attributes of the Playback element may be used in combination with this element. They would limit the period within which the content may be played in addition to the limit on the number of playbacks.
Rental—a choice between EndTime and Interval elements. EndTime is the expiration time for the content after which it must not be usable. Interval is a period of time within which the content is usable and has the following attribute:
StartOnFirstUse—a boolean flag. When set to “Y”, it means that the rental interval doesn't start until the first time that the content is accessed, e.g., the first time that a decryption key for this content is retrieved from the content license. If this flag value is “N”, the rental interval starts as soon as a content license is first created. Once a rental interval is started, the Rental element must be modified with the Interval replaced by EndTime, which is calculated as the starting time of the interval+Interval.

The startDate and endDate attributes of the Playback element may be used in combination with the Rental element and StartOnFirstUse set to “Y”. They would provide an absolute time interval within which the content may be played in addition to the relative time limit on the period within which content playbacks may be started.
PauseTime—max number of minutes of pause time allowed per occasion. What “occasion” means could vary between different rendering applications.
   MulticastLimit

Limits the number of devices that the content can be simultaneously streamed to from a residential home gateway. This does not have to be an IP multicast. If the same content is being streamed to several clients simultaneously over multiple point-to-point connections, that would also qualify as a multicast in this case.

A value of 0 means that the number of such simultaneous devices is unrestricted. Each single multicast of the content is counted as a single playback.

Fingerprint

Identifies a fingerprint algorithm that is to be inserted into the content as it is being decompressed and delivered over an external analog or digital uncompressed interface. Several Fingerprint elements may be included in order to provide a choice to the rendering device. This element has the following attribute:
fingerprintID—an identifier for a fingerprint algorithm. Which fingerprint algorithms may be used is TBD. When the fingerprint algorithms are selected, it may become necessary to add some additional attributes to this element.
   DeviceCapabilities

This element places some requirements on a device that is allowed to render or store a copy of this content. It has the following attributes:
SecurityLevelToRender—minimum security level of a device required to render this content. Currently 6 security levels have been defined for IPRM.
SecurityLevelToCopy—minimum security level of a device required to save a copy of this content. In practice this security level will be greater or equal to SecurityLevelToRender.
CodecInSecureHW—if this boolean flag is ‘Y’, a device is required to decompress this content within a secure hardware module.
WatermarkInSecureHW—if this boolean flag is ‘Y’, a device is required to detect a watermark embedded in this content within a secure hardware module.
FingerprintInSecureHW—if this boolean flag is ‘Y’, a device is required to insert a fingerprint into this content within a secure hardware module.
   OptionCost Element

OptionCost is a sub-element of a RenewalOption and identifies the cost of using this option and this set of content usage rules to either renew a license or to buy a superdistributed copy of the content. The attributes of OptionCost are:
currency—currency used to specify the cost. A default value of “USD” identifies US dollars.
format—format used to specify the value of the currency attribute, default is ISO4217 (a 3-letter achronym).

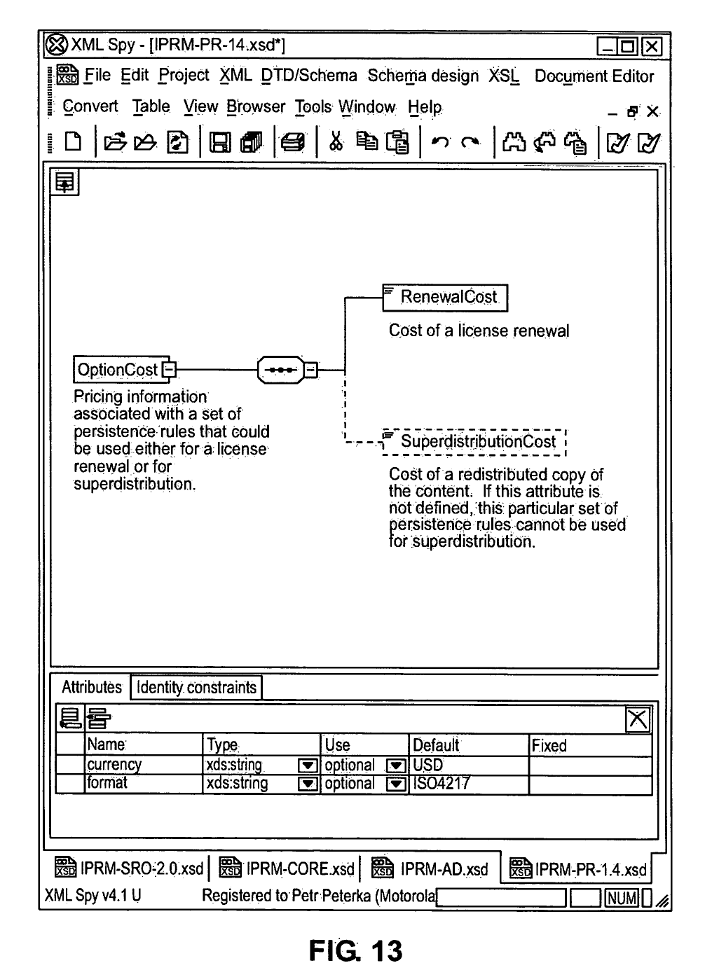

The OptionCost element is illustrated in FIG. 13.

The OptionCost Element is a sequence of one or more of the following:
RenewalCost—the cost of renewing a license with this option that contains this set of content usage rules. This is a required element of the sequence.
RedistributionCost—the cost of buying a superdistributed copy of the content using this option with this set of content usage rules. When this optional element is present, the same set of content usage rules may be used for both renewing a license and buying a superdistributed copy of the content. The price may be different in the two cases, e.g., you can get a bigger discount when renewing license to the content you already purchased. This element is optional as not all renewal options may also be used for superdistribution. There is currently no provision to have a set of content rules that may be used only for superdistribution but not for content renewal. If such need arises, in the future the RenewalCost could be made optional as well.
   CopyProtectionRules Definition

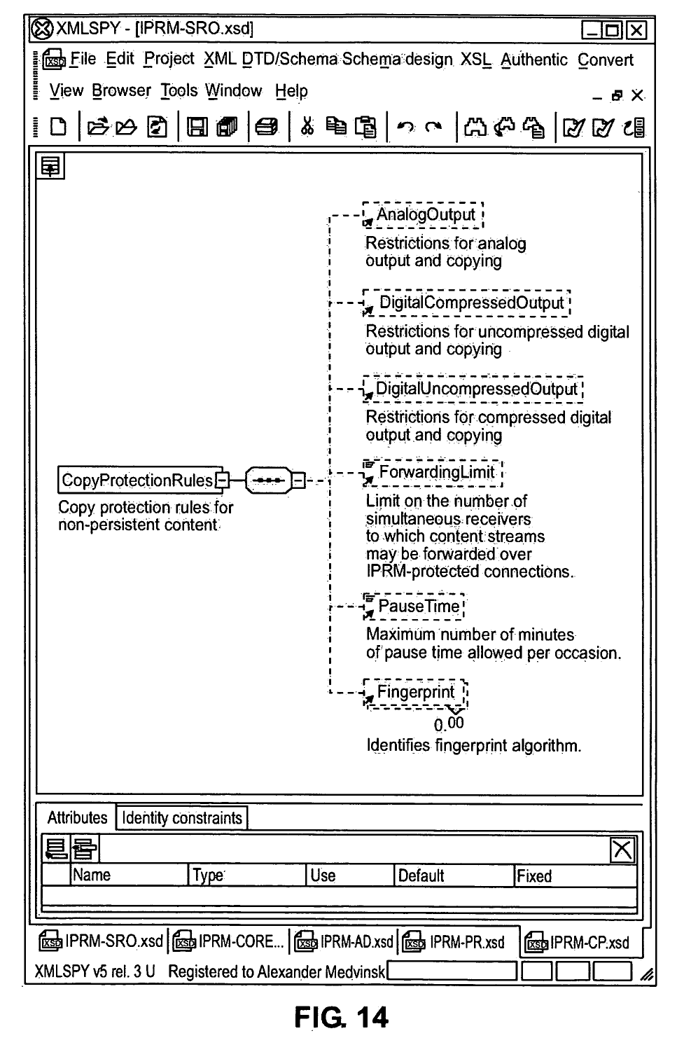

The CopyProtectionRules element is the root element of the IPRM Copy Protection Rules schema. It can either be utilized as a separate XML document that is included inside the SRO along with the Session Rights document, or it can be included directly inside the Session Rights as part of one of the PurchaseOption elements. This element contains copy protection rules associated with forwarding content over output ports and defines rules which are a subset of the rules in IPRMPersistentEntitlements, which is illustrated in FIG. 14.

CopyProtectionRules is a sequence of the following elements:
AnalogOutput—restricts copies over an analog interface as described above.
DigitalCompressedOutput—restricts copies over a digital compressed interface as described above.
DigitalUncompressedOutput—restricts copies over a digital uncompressed interface as described above.
ForwardingLimit—limit on the number of simultaneous receivers to which content streams may be forwarded over IPRM-protected connections. The value of 0 means that content cannot be forwarded.
PauseTime—maximum number of minutes of pause time allowed per occasion. What “occasion” means could vary between different rendering applications.
Fingerprint—identifies a fingerprint algorithm that is to be inserted into the content as it is being decompressed and delivered over an external analog or digital uncompressed interface. Several Fingerprint elements may be included in order to provide a choice to the rendering device.

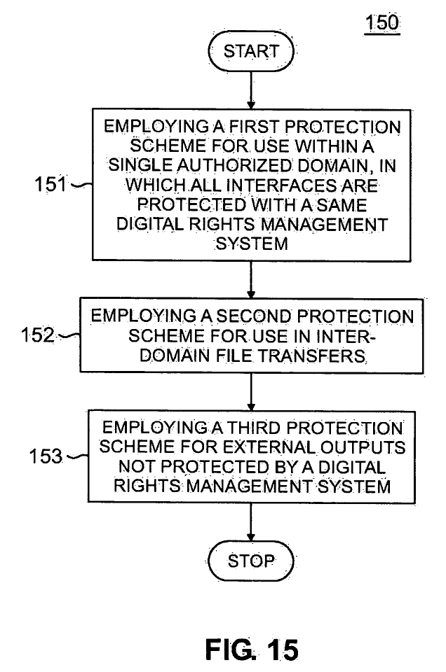

turning to FIG. 15, shown therein is a copyright protection method 150 for one or more files according to another aspect of the present invention. This method can be employed in any situation in which intra-domain transfers or copy operations are desired as well as inter-domain transfers or copy operations. Moreover, the exemplary embodiment 150 can be employed where outputs from the system are not controlled by a digital rights management system.

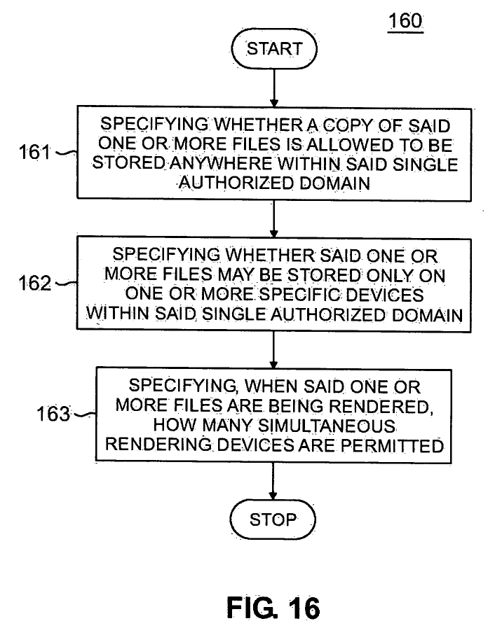

In element 151, the exemplary embodiment 150 employs a first protection scheme (such as element 160, see FIG. 16) for use within a single authorized domain, in which all interfaces are protected with a same digital rights management system.

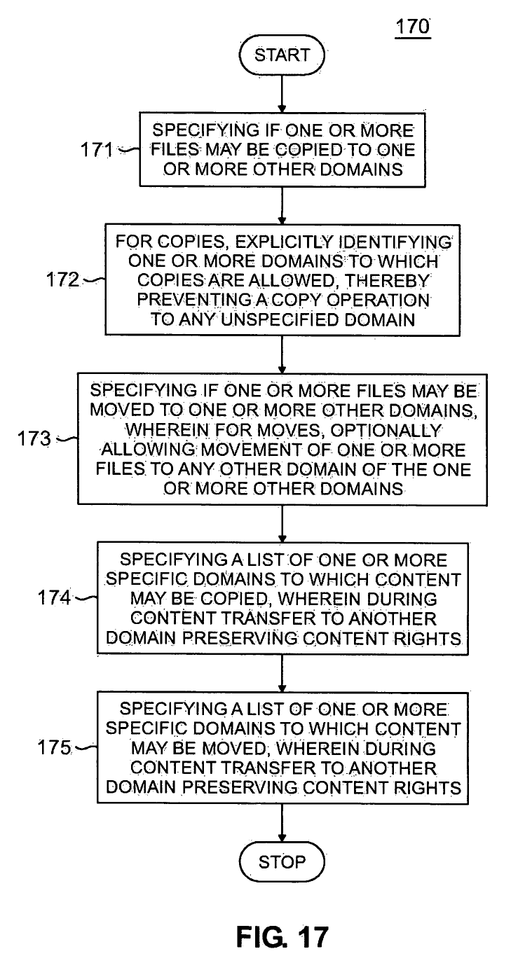

In element 152, the exemplary embodiment 150 employs a second protection scheme (such as element 170, see FIG. 17) for use in inter-domain file transfers.

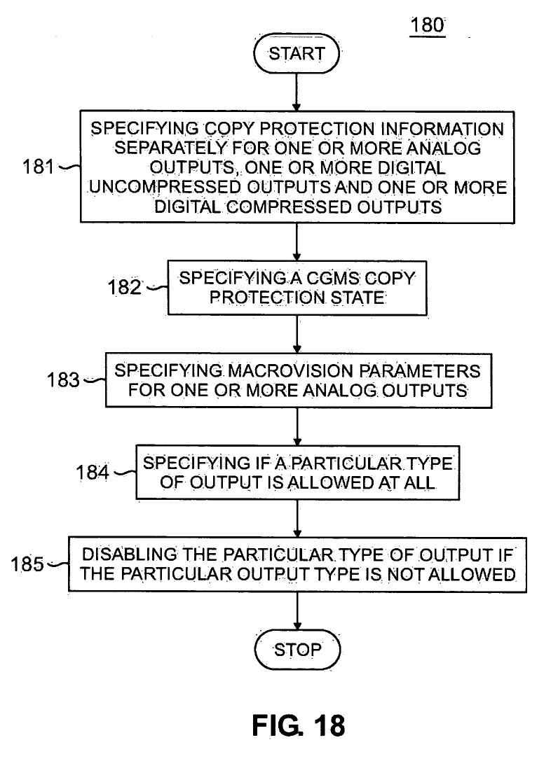

In element 153, the exemplary embodiment 150 employs a third protection scheme (such as element 180, see FIG. 18) for external outputs not protected by a digital rights management system.

Turning to FIG. 16, shown therein is an exemplary embodiment 160 of a first protection scheme according to yet another aspect of the present invention, which first protection scheme may be employed in exemplary embodiment 150.

In element 161, the exemplary embodiment 160 specifies whether a copy of the one or more files is allowed to be stored anywhere within the single authorized domain.

In element 162, the exemplary embodiment 160 specifies whether the one or more files may be stored only on one or more specific devices within the single authorized domain.

In element 163, the exemplary embodiment 160 specifies, when one or more files are being rendered, how many simultaneous rendering devices are permitted.

Turning to FIG. 17, shown therein is an exemplary embodiment 170 of a second protection scheme, which may be employed in exemplary embodiment 150 according to still another aspect of the present invention.

In element 171, the exemplary embodiment 170 specifies if one or more files may be copied to one or more other domains.

In element 172, the exemplary embodiment 170, for copies, explicitly identifies one or more domains to which the copies are allowed, thereby preventing a copy operation to any unspecified domain.

In element 173, the exemplary embodiment 170 specifies if one or more files may be moved to one or more other domains, wherein for moves, optionally allowing movement of said one or more files to any other domain of said one or more other domains.

In element 174, the exemplary embodiment 170 specifies a list of one or more specific domains to which content may be copied, wherein during content transfer to another domain preserving content rights.

In element 175, the exemplary embodiment 170 specifies a list of one or more specific domains to which content may be moved, wherein during content transfer to another domain preserving content rights.

Turning to FIG. 18, shown therein is an exemplary embodiment 180 of a third protection scheme, which may be employed in exemplary embodiment 180 according to yet another aspect of the present invention.

In element 181, the exemplary embodiment 180 specifies copy protection information separately for one or more analog outputs, one or more digital uncompressed outputs and one or more digital compressed outputs.

In element 182, the exemplary embodiment 180 specifies a CGMS Copy protection state.

In element 183, the exemplary embodiment 180 specifies MACROVISION parameters for one or more analog outputs.

In element 184, the exemplary embodiment 180 specifies if a particular type of output is allowed at all.

In element 185, the exemplary embodiment disables the particular type of output if the particular output type is not allowed.

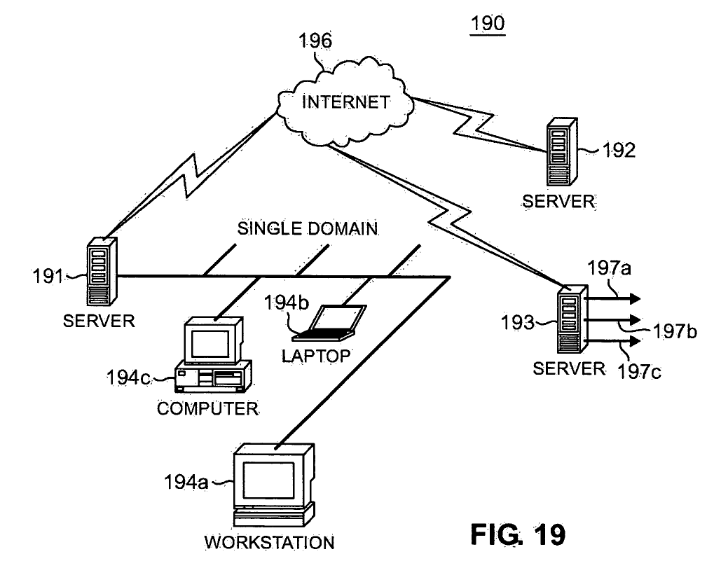

Turning to FIG. 19, shown therein is an apparatus 190 for copyright protection for one or more files. The apparatus includes a first processor 191, such as a server, coupled via a network 195, such as a local area network, to various interfaces 194a-c, such as a workstation 194a, a laptop 194b and a computer 194c. The server 191 is also coupled to another server or processor 192 via the Internet 196 or other computer network. The local area network 195 is an example of a single domain. Servers 191-192 are also coupled to another server or processor 193, which includes several outputs 197a-c.

The first processor or server 191 employs a first protection scheme, such as exemplary embodiment 160 shown in FIG. 16, for use within the single authorized domain 195 (e.g., the local area network in this case), in which all interfaces 194a-c are protected with a same digital rights management system.

The second processor or server 192 employing a second protection scheme, such as exemplary embodiment 170 for use in inter-domain file transfers, such as transfers from server 192 to server 193.

The third processor or server 193 employs a third protection scheme, such as exemplary embodiment 180 shown in FIG. 18, for external outputs 197a-c not protected by a digital rights management system.

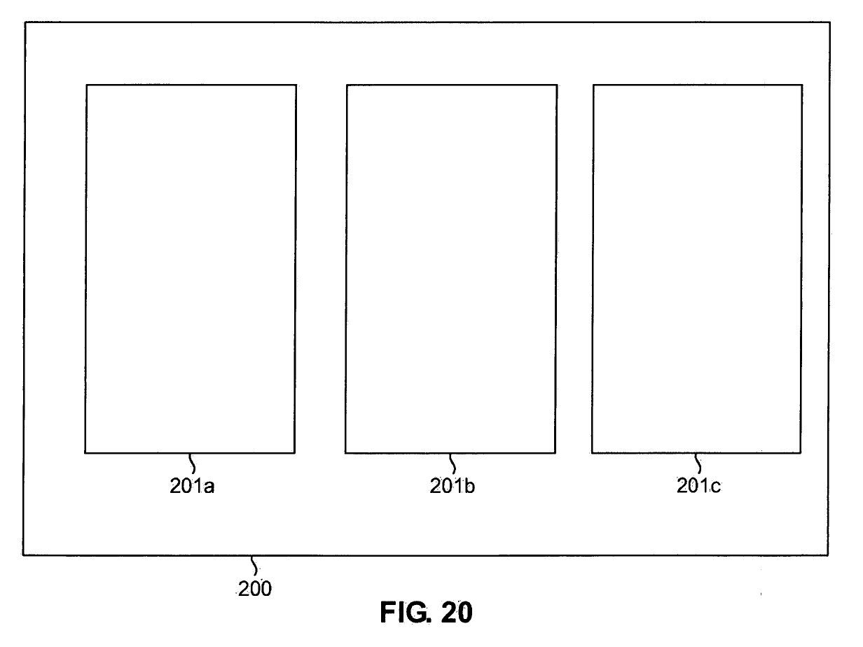

Turning to FIG. 20, shown therein is an exemplary embodiment of a computer readable medium 200 having stored therein instructions causing a processor, such as servers 191-193, to implement a copyright protection method, such as exemplary embodiment 150 for one or more files.

The exemplary embodiment 200 includes a first section 201a storing instructions causing a first processor to employ a first protection scheme, such as exemplary embodiment 160 for use within a single authorized domain, such as local area network 195, in which all interfaces, such as computers 194a-c, are protected with a same digital rights management system.

The exemplary embodiment 200 includes a second section 201b storing instructions causing a second processor to employ a second protection scheme, such as exemplary embodiment 170 for use in inter-domain file transfers.

The exemplary embodiment 200 may include a third section 201c storing instructions causing a third processor to employing a third protection scheme, such as exemplary embodiment 180 for external outputs, such as analog outputs 197a, digital compressed outputs 197b and uncompressed digital outputs 197c, which are not protected by a digital rights management system.

The first, second and third processors shown in FIG. 19 may be the same processor executing two or three different processes, or two processors executing three processes between them.

Moreover, the computer readable medium may be distributed amongst separate devices so that one or more processors can execute each of the sections 201a-c. The computer readable media comprises any media capable of storing instructions to be read by a processor, such as magnetic, optic or other media. Examples include ROM, RAM, EEPROM, EPROM, CD-ROM, DVD, magnetic disks, optical disks, magnetic tapes, magnetic sticks, organic memory, etc.

Processors 191-193 comprise standard processors capable of executing the instructions set forth herein, such as standard servers, computers, or electronic devices.

Although various embodiments are specifically illustrated and described herein, it will be appreciated that modifications and variations of the invention are covered by the above teachings and are within the purview of the appended claims without departing from the spirit and intended scope of the invention. Furthermore, these examples should not be interpreted to limit the modifications and variations of the invention covered by the claims but are merely illustrative of possible variations.

What is claimed is:

1. A digital rights management method (240) for protecting digital content comprising:
associating (241) one or more sets of content usage rules with a protected digital content;
for each set of content usage rules, associating (242) one or more prices for protected digital content, corresponding to each of one or more subscription service types under a copyright protection scheme to access or store the protected content; and
permitting (245) a user to access the protected digital content, protected under a selected set of content usage rules and at one of the one or more associated prices that is associated with a subscription service type to which the user is currently subscribed.

2. The method (240) according to claim 1, wherein at least one of the sets of content usage rules includes a persistence element.

3. The method (240) according to claim 1, further comprising:
permitting (245) a user to store the protected content in accordance with one of the one or more sets of content usage rules at one of the one or more prices associated with the one of the one or more sets of content usage rules that is associated with the subscription service type to which the user is currently subscribed.

4. The method (240) according to claim 1, further comprising:
permitting (245) a subscriber to access the protected content for free if a price is not listed.

5. The method (240) according to claim 1, wherein a persistence element comprises one or more of the following: a temporary recording, a specified time-length recording and a permanent recording.

6. A digital rights management method (250) for protecting digital content comprising:
providing (251) a purchase option element for each protected digital content, which includes specifying a set of content usage rules for each protected content in a copyright protection scheme; and
specifying (252) a cost for each protected digital content associated with the set of content usage rules.

7. The method (250) according to claim 6, further comprising:
specifying (253) one or more subscription groups for each set of content usage rules for the protected digital content, which subscription group includes one or more subscription services and one or more associated incremental discounts for the protected digital content based on the one or more associated subscription services.

8. The method (250) according to claim 6, further comprising:
permitting (256) a subscriber to access and store the content at a price based on the first discount after adjusting the cost based on an associated first incremental discount, if any, that is associated with the subscriber's subscription service and the specified persistence element.

9. The method (250) according to claim 6, further comprising:
permitting (256) a subscriber to access and store the content at a price based on the second discount after adjusting the cost based on an associated second incremental discount, if any, associated with the subscriber's subscription service

10. The method (250) according to claim 6, further comprising:
receiving (254) a request from a user indicating a desired content and a desired set of content usage rules.

11. The method (250) according to claim 6, further comprising:
determining a price for the request based on the user's subscription type, a desired content and set of content usage rules.

12. An apparatus (10) for copyright protection of content comprising:
a server (12) including a memory storing a copyright protection scheme and a processor enforcing the copyright protection scheme to protect the one or more files, said copyright protection scheme (250) including:
providing (251) a purchase option element for each protected content, which includes specifying a set of content usage rules;
specifying (252) a cost for each protected content associated with a set of content usage rules; and
specifying (253) a subscription group for each protected content in the persistent and non-persistent content usage rules, which subscription group includes one or more subscription services and one or more associated incremental discounts for the protected content based on the one or more associated subscription services.

13. The apparatus (10) according to claim 12, wherein said server (12) permits (256) a subscriber to access and store the content at a price based on the first discount after adjusting the cost based on an associated first incremental discount, if any, that is associated with the subscriber's subscription service and the specified persistence element.

14. The apparatus (10) according to claim 12, wherein said server (12) permits (256) a subscriber to access and store the content at a price based on the second discount after adjusting the cost based on an associated second incremental discount, if any, that is associated with the subscriber's subscription service.

15. The apparatus (10) according to claim 12, wherein said server (12) receives (254) a request from a user indicating a desired content and a selected set of content usage rules.

16. The apparatus (10) according to claim 15, wherein said server (12) determines (255) a price for the request based on the user's subscription type, a desired content and selected set of content usage rules.

17. A computer readable medium (200) having stored therein instructions causing a processor (12) to implement a copyright protection method (250) for content comprising:
providing (251) a purchase option element for each protected content, which includes specifying a set of content usage rules;
specifying (252) a cost for each protected content associated with a set of content usage rules; and
specifying (253) a subscription group for each protected content in the persistent and non-persistent copyright protection rules, which subscription group includes one or more subscription services and one or more associated incremental discounts for each protected content based on the one or more associated subscription services.

18. The computer readable medium (200) according to claim 17, instructions cause the processor (12) to permit (256) a subscriber to access the content at a price based on the first discount after adjusting the cost based on an associated first incremental discount, if any, that is associated with the subscriber's subscription service and the specified persistence element.

19. The computer readable medium (200) according to claim 17, wherein said instructions cause the processor (12) to permit (256) a subscriber to access and store the content at a price based on the second discount after adjusting the cost based on an associated second incremental discount, if any, that associated with the subscriber's subscription service.

20. The computer readable medium (200) according to claim 17, wherein said instructions cause the processor (12) to receive (254) a request from a user indicating a desired content and a set of content usage rules and to determine (255) a price for the request based on the user's subscription type, a desired content and the selected set of content usage rules.
